(19) United States
(12) Patent Application Publication
(10) Pub. No.: US 2006/0068334 A1
(43) Pub. Date: Mar. 30, 2006

(54) Phase-shifting optical maskless lithography enabling asics at the 65 and 45 NM nodes

(75) Inventors: Torbjorn Sandstrom, Pixbo (SE); Ulric Ljungblad, Molndal (SE)

Correspondence Address: HAYNES BEFFEL & WOLFELD LLP, P O BOX 366, HALF MOON BAY, CA, 94019, US

(73) Assignee: Micronic Laser Systems AB, Taby (SE)

(21) Appl. No.: 11/228,022

(22) Filed: Sep. 15, 2005

Related U.S. Application Data
(63) Continuation-in-part of application No. 11/066,828, filed on Feb. 25, 2005.
(63) Continuation-in-part of application No. 11/008,566, filed on Dec. 10, 2004.
(60) Provisional application No. 60/610,012, filed on Sep. 15, 2004.
(60) Provisional application No. 60/547,614, filed on Feb. 25, 2004.
(60) Provisional application No. 60/552,598, filed on Mar. 12, 2004.
(60) Provisional application No. 60/529,114, filed on Dec. 15, 2003.
(60) Provisional application No. 60/537,887, filed on Jan. 22, 2004.

(51) Int. Cl. G03C 5/00

(52) U.S. Cl. 430/322

(57) ABSTRACT

Phase stepped and paired piston SLM configurations are described, with attention to rasterization and image stability. In contrast to attenuated phase-shift reticle performance of simple titling mirror SLMs, these configuration have phase shifting capabilities emulating a hard phase shift reticle and beyond. To use a straight-forward rasterization architecture where individual pixels are determined by the local pattern data, the SLM is operated so that the complex amplitude created by a mirror or mirror pair is confined to the real axis. The tilting phase-step mirror SLM gives a new set of rules for lithography: no penalty for phase shift over binary, no penalty for OPC verses non-OPC pattern, seamless pattern decompositions, optimal tones for each pattern, etc. This gives performance and flexibility never seen before.

### RELATED APPLICATION

This application claims the benefit of and incorporates by reference U.S. Provisional App. No. 60/610,012 filed 15 Sep. 2004 and No. 60/615,88 filed 4 Oct. 2004, both filed by the same inventors under the same title as this application. It continues-in-part U.S. application Ser. No. 11/066,828 by Torbjörn Sandström, filed on 25 Feb. 2005, entitled “RET for Optical Maskless Lithography”, which claims the benefit of and incorporates by reference U.S. Provisional App. No. 60/547,614 by Torbjörn Sandström, entitled “RET for Optical Maskless Lithography” filed on 25 Feb. 2004 and U.S. Provisional App. No. 60/552,598 by Torbjörn Sandström and Hans Martinsson, entitled “RET for Optical Maskless Lithography (OML)” filed on 12 Mar. 2004; and continues-in-part U.S. application Ser. No. 11/008,566 by Ulric Ljungblad, filed on 10 Dec. 2004, entitled “Method and Apparatus for Patterning a workpiece and Methods for Manufacturing the Same”, which claims the benefit of and incorporates by reference U.S. Provisional App. Nos. 601528,488, filed on Dec. 11, 2003, U.S. provisional application 60/529,114, filed on Dec. 15, 2003, and U.S. provisional application 60/537,887, filed on Jan. 22, 2004.

Incorporated by reference to illustrate the technology applied in this application are several previously filed applications. These include: U.S. Provisional App. Nos. 60/415,509, entitled “Resolution Extensions in the Sigma 7000 Imaging SLM Pattern Generator” by inventors Torbjörn Sandström and Niklas Eriksson, filed on 1 Oct. 2002; 60/444,417, entitled “Further Resolution Extensions for an SLM Pattern Generator” by inventors Torbjörn Sandström and Niklas Eriksson, filed on 3 Feb. 2003; and 60/455,364, entitled “Methods and Systems for Process Control of Corner Feature Embellishment” by inventors Torbjörn Sandström, Hans Martinsson, Niklas Eriksson and Jonas Hellgren, filed on 17 Mar. 2003. These further include the international application designating the United States submitted and to be published in English, App. No. PCT/SE02/02310, entitled “Method and Apparatus for Patterning a Workpiece” by inventor Torbjörn Sandström and Peter Duerr, filed on 11 Dec. 2002 and claiming priority to the Swedish Application No. 0104238-1 filed on 14 Dec. 2001; and the international application designating the United States submitted and to be published in English, App. No. PCT/EP03/04283, entitled “Method and Apparatus for Controlling Exposure of a Surface of a Substrate” by inventors Torbjörn Sandström and Peter Duerr, filed on 24 Apr. 2003. These provisional and international applications are hereby incorporated by reference.

This application is related to the international application designating the United States submitted and published in English, App. No. PCT/SE02/2004/000936, which claims priority to U.S. patent application Ser. No. 10/460,765, entitled “Method for High Precision Printing of Patterns” by inventor Torbjörn Sandström, issued 21 Dec. 2004 as U.S. Pat. No. 6,833,854. This application is further related to U.S. patent application Ser. No. 10/462,010, “Methods and Systems for Improved Boundary Contrast” by inventor Torbjörn Sandström, both filed on 12 Jun. 2003. The international application and both of the US applications are hereby incorporated by reference. It is also related to U.S. patent application Ser. No. 09/954,721, entitled “Graphics Engine for High Precision Lithography” by inventors Martin Olsson, Stefan Gustavson, Torbjörn Sandström and Per Elmfors, filed on 12 Sep. 2001, which is hereby incorporated by reference (“Graphics Engine application”). It is further related to U.S. patent application Ser. No. 10/238,220, entitled “Method and Apparatus Using an SLM” by inventors Torbjörn Sandström and Jarek Luberek, filed on 10 Sep. 2002. (“Blanket Gray Calibration application”), which claims the benefit of provisional Patent Application No. 60/323,017 entitled “Method and Apparatus Using an SLM” by inventors Torbjörn Sandström and Jarek Luberek, filed on 12 Sep. 2001, both of which are hereby incorporated by reference. It is also related to U.S. patent application Ser. No. 09/992,653 entitled “Reticle and Direct Lithography Writing Strategy” by inventor Torbjörn Sandström, filed on 16 Nov. 2001 which is a continuation of application Ser. No. 90/665,288 filed 18 Sep. 2000, which is hereby incorporated by reference (“Writing Strategy application”).

### BACKGROUND OF THE INVENTION

The present invention relates to phase shifting optical maskless lithography (OML). In particular, it relates to devices that produce phase shifted illumination and strategies for using such devices to expose radiation sensitive layers on workpieces.

For general background regarding the types of phase-shift mask techniques analogous to the technology disclosed herein, reference is suggested to the article by Wilhelm Maurer, entitled “Application of Advanced Phase-Shift Masks”, which was accessible at http://www.reed-electronics.com/semiconductor/index.asp?layout=articlePrint&articleID=CA319210, as of Mar. 12, 2004.

Moore's law promises exponential growth in computer power at diminishing prices. This dynamic growth of processing power might lead one to think that semiconductor device manufacturing would be an adventuresome business, like wild-catting for oil. Just the opposite is true. Because manufacturing batches are very valuable and manufacturing processes are sensitive to even small mistakes, semiconductor device manufacturing is a conservative business. Qualification cycles and standards for new equipment, new processes and modifications of old equipment or processes are lengthy and demanding. Even a small change is vetted extensively, before being released to production.

Applications commonly assigned, many of which have overlapping inventorship, have described an SLM-based system well-adapted to make masks. Additional work has been done to adapt the SLM technology to direct writing of chips.

An opportunity arises to introduce an SLM-based system that uses phase shifting and strong phase shifting and to describe methods of using such a system. Producing patterns directly from a phase-shifting SLM, without a binary or phase-shifting reticle, has the potential to enhance manufacture of prototype and small production run designs. It also has the potential to study design and production variants, both intended and with process error margins, which are not practical to study in reticle-based lithography.

### SUMMARY OF THE INVENTION

The present invention relates to phase shifting phase shifting OML. In particular, it relates to devices that produce phase shifted illumination and strategies for using such devices to expose radiation sensitive layers on workpieces. Particular aspects of the present invention are described in the claims, specification and drawings.

### BRIEF DESCRIPTION OF THE DRAWINGS

FIG. 1 provides a schematic representation of the OML image generating system.

FIG. 2 depicts the wafer is scanning at a constant velocity, short pulse lengths utilized in OML, with micro-steps from stamp to stamp.

FIG. 3 outlines an OML system architecture.

FIG. 4 shows the results of calibration of mirrors.

FIG. 5 A preliminary optical design for the projection optics.

FIG. 6 illustrates a dense 150 nm line/space pattern in chrome written using a Sigma 7300 mask writer.

FIG. 7 shows composite CD uniformity for an 11×11 matrix of samples over 121 sq. mm.

FIG. 8 illustrates the definition of the complex amplitude of reflected light, A.

FIG. 9 a band in the complex plane of reflected light amplitude, along the real axis, that has practical application in lithography.

FIG. 10 illustrates the real part of the complex integrated amplitude versus the phase angle (in degrees) at the edge of tilting mirrors.

FIG. 11 illustrates three types of mirrors and their trajectories through actuation.

FIG. 12 illustrates differences in errors from a PSM mask with a phase error and from a tilting phase-step mirror with a step height error.

FIG. 13a shows an SLM mirror driven along the trajectory during actuation Tm between two states P and Q, where P is clear and Q is shifted. The modulus of Q is larger than the modulus of P.

FIG. 13b shows the same mirror at a higher exposure dose than in FIG. 13a.

FIGS. 14a and 14b compare a mirror that hinges at one edge with a central axis tilting mirror.

FIG. 15 depicts a datapath that drives four arbitrary real tones based on combination of two layers.

FIGS. 16a and 16b illustrate combining pairs of pistons into square units and complex amplitudes that result from operating them in pairs.

FIGS. 17a-17n show examples on how the proposed SLM and data path could be used.

FIG. 18 illustrates formation of gate-like structures in a single pass by phase edges.

FIG. 19 depicts how the maskless scanner appears to the designers and the fab.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

For low-volume runs, Optical Maskless Lithography provides an attractive alternative for mask-based lithography due to ever-increasing reticle costs. Foundries and ASIC fabs are finding that reticles are an increasingly dominating part of their manufacturing costs, especially for small series production. OML provides a cost-effective alternative while maintaining process compatibility with existing fab technologies.

Optical maskless technology that does not provide phase-shifting capability would soon become obsolete. Phase-shifting is on everybody's roadmap for the 65 nm node and forward. Even metal layers will be phase-shifted. Infrastructure for design and production of phase-shifting reticles has taken a long time to develop, but for node 65 nm and onwards it will become an integral part of most processes. This will not happen without a cost: phase-shifting reticles will continue to be expensive and have long lead times. Some products, mainly memory processors, FPGAs and circuits for large-volume consumer goods will swallow these costs, but for other products, such as ASICs, industrial and military products, the volumes will be too small and phase-shifting will often be economically out of reach. Previously most products have benefited from moving to smaller design rules, because of the smaller foot-print, but onwards only long-runners and products for which gate speed is worth a premium will migrate. It seems that large parts of the industry will split off from Moore's Law.

Although mask cost and lead-times are not the only hurdles to migrating new products to smaller nodes, there is likely to be a large segment of products where optical maskless technology could be enabling. It also helps long-runners by lowering the cost of engineering and experimental designs, thereby stimulating learning, helping to improve performance and raising yield. If optical maskless technology in this way can facilitate learning the value of the accumulated gain for the industry over a number of years will be very large. Is there a maskless solution that can provide enabling phase-shifting functionality? This communication will argue that there is:

Micronic's SLM lithography architecture has been described in a series of papers and patents. The Sigma maskwriter uses square tilting mirrors and pixel-by-pixel rasterization similar to that used in any computer graphic system. The unique physics of the partially coherent illumination, which gives the SLM maskwriter superior imaging performance to raster-scan and incoherent pattern generators, can with this particular design be represented quite simply by an additional calibration step. The SLM technology was initially presented as analog to binary masks, i.e. using the amplitude values 0.00+0.00j to 1.00+0.00j but does indeed allow the lower limit to be driven to −0.20+0.00j. Thereby the analog would more properly be an attenuated phase-shift reticle, and the SLM gives the same increase in contrast as an Att-PSM.

Introduction

An Optical Maskless Scanner with a wavelength of 193 nm and 0.93 NA for resolution compatible with the 65 nm node is achievable. A throughput of 5 wph (300 mm) is desired.

The spatial light modulator (SLM) and data path technologies, developed by Micronic for the SIGMA line of mask-writers, provide a computer-controlled reticle that possesses imaging and optical properties similar to a normal reticle. One embodiment of the proposed Optical Maskless Scanner combines an array of multiple SLMs with the ASML TWINSCAN platform and uses 193 nm technology to ensure optimal process transparency in the fab. The reticle stage and infrastructure is replaced with an image generating subsystem consisting of a set of SLMs and a data delivery system capable of providing nearly 250 GPixels/sec. A newly designed optical column has a maximum NA of 0.93, making it compatible with ASML's TWINSCAN series of conventional lithography scanners, including support for all illumination modes available in conventional scanners.

Maskless Lithography approaches require high data volumes. Unlike e-beam, Optical Maskless Lithography has no inherent physical throughput limitations. SLM pattern generation technology lends itself to throughput scaling. The pattern conversion path from the input file through the rasterizer and SLM down to the image in the resist can be made parallel by using multiple SLMs simultaneously. While the challenge would be formidable for a random pattern, the nature of repeated scanner fields on the wafer simplifies the problem.

The large commonality in the image formation techniques between the Optical Maskless Scanner and a conventional scanner is expected to result in producing the same level of imaging performance on both types of systems. The image generation process adopts existing enhancement techniques (e.g. OPC) from mask-based lithography, facilitating the transition from maskless to mask-based mass production as production ramps up. The table below shows the preliminary systems specifications for one embodiment of an OML tool.

| Parameter | Specification | |
|---|---|---|
| PO Interface | | |
| PO Numerical Aperture | 0.7 to 0.93 | |
| PO magnification | 267x | |
| Usable Depth of Focus (uDOF) | ±0.1 | μm |
| Pixel Size @ Wafer Plane | 30 | nm |
| Throughput | | |
| 300 mm wafers: 125 exposures, 16 × 32 mm, | 5 | wph |
| 30 mJ/cm² dose | | |
| 200 mm wafers: 58 exposures, | 10 | wph |
| 16 × 32 mm, 30 mJ/cm² dose | | |

Using Micro-Mirrors as a Reticle

Optical Maskless Lithography strives to combine conventional (i.e. mask-based) photolithography scanners with a fixed array of multiple micro-mechanical SLMs used to generate the mask pattern in real-time, in place of a reticle.

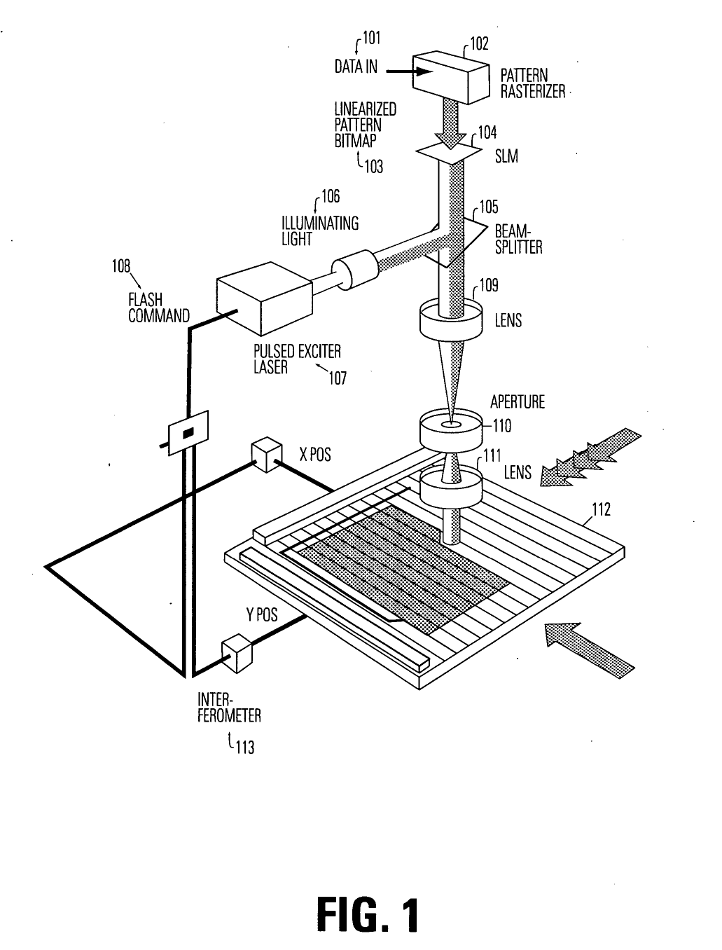

FIG. 1 provides a schematic representation of the Optical Maskless image generating system. Aspects of an SLM pattern generator are disclosed in the references identified above. The workpiece to be exposed sits on a stage 112. The position of the stage is controlled by precise positioning device, such as paired interferometers 113.

The workpiece may be a mask with a layer of resist or other exposure sensitive material or, for direct writing, it may be an integrated circuit with a layer of resist or other exposure sensitive material. In the first direction, the stage moves continuously. In the other direction, generally perpendicular to the first direction, the stage either moves slowly or moves in steps, so that stripes of stamps are exposed on the workpiece. In this embodiment, a flash command 108 is received at a pulsed excimer laser source 107, which generates a laser pulse. This laser pulse may be in the deep ultraviolet (DUV) or extreme ultraviolet (EUV) spectrum range. The laser pulse is converted into an illuminating light 106 by a beam conditioner or homogenizer.

A beam splitter 105 directs at least a portion of the illuminating light to an SLM 104. The pulses are brief, such as only 20 ns long, so any stage movement is frozen during the flash. The SLM 104 is responsive to the datastream 101, which is processed by a pattern rasterizer 102. In one configuration, the SLM has 2048×512 mirrors that are 16×16 μm each and have a projected image of 80×80 nm. In another configuration, the SLM has mirrors that are 8×8 μm with a much smaller projected image. It includes a CMOS analog memory with a micro-mechanical mirror formed half a micron above each storage node.

The electrostatic forces between the storage nodes and the mirrors actuate the mirrors. The device works in diffraction mode, not specular reflectance, and needs to deflect the mirrors by only a quarter of the wavelength (62 nm at 248 nm or 48 nm at 193 nm) to go from the fully on-state to the fully off-state. To create a fine address grid the mirrors are driven to on, off and 63 intermediate values. The pattern is stitched together from millions of images of the SLM chip. Flashing and stitching proceed at a rate of 1000 to 4000 stamps per second. To reduce stitching and other errors, the pattern is written two to four times with offset grids and fields. Furthermore, the fields may be blended along the edges.

The mirrors are individually calibrated. A CCD camera, sensitive to the excimer light, is placed in the optical path in a position equivalent to the image under the final lens. The SLM mirrors are driven through a sequence of known voltages and the response is measured by the camera. A calibration function is determined for each mirror, to be used for real-time correction of the grey-scale data during writing. In the data path, the vector format pattern is rasterized into grey-scale images, with grey levels corresponding to dose levels on the individual pixels in the four writing passes. This image can then be processed using image processing. The final step is to convert the image to drive voltages for the SLM. The image processing functions are done in real time using programmable logic. Through various steps that have been disclosed in the related patent applications, rasterizer pattern data is converted into values 103 that are used to drive the SLM 104.

In this configuration, the SLM is a diffractive mode micromirror device. A variety of micromirror devices have been disclosed in the art. In an alternative configuration, illuminating light could be directed through a micro-shutter device, such as in LCD array or a micromechanical shutter.

The OML uses an array of SLMs, based on an extension of the 1 MPixel SLM technology used in Micronic's SIGMA mask-writers. The SLMs are illuminated by a pulsed excimer laser source through an optical system in front of the SLMs, which project a de-magnified image of the SLM on to the wafer. In the OML tool, each SLM pixel is an 8 μm×8 μm tilting mirror. When all mirrors are flat ( i.e. relaxed), the SLM surface acts as a mirror and reflects all light specularly through the projection optics. This corresponds to clear areas on the corresponding reticle. When the mirrors are fully tilted, the surface is non-flat and the light is lost by being diffracted outside of the stop of the projection optics; thus, dark areas are produced on the wafer. Intermediate tilt positions will reflect part of the light into the projection optics, i.e. gray, areas are produced.

The SLM chip consists of a CMOS circuit similar to those in reflection LCD devices, and functionally similar to the circuitry for a computer TFT screen. Pixel cells include a storage capacitor and transistor to allow the storage node to be charged to an analog voltage and then isolated. Pixels are addressed in sequence during the loading of a new frame by normal matrix addressing, i.e. by scanning every column and row and loading an analog voltage into each one. The area is divided into a large number of load zones that are scanned simultaneously, so that the entire chip is reloaded in less than 250 msec.

In pixel cells, the storage node is connected to an electrode under part of the mirror. The electrostatic force pulls the mirror and causes it to tilt. The exact angle is determined by the balance between the analog voltage and the stiffness in the flexure hinge, i.e. the device has analog action and the loaded voltage can control the tilt angle in infinitely small increments. The actual resolution is limited by the DACs providing the drive voltages.

Intuitively, it would appear that the tilting mirrors produce a phase image on the wafer. Phase images are known to produce artifacts when scanned through the focus range. In this case, however, the small size of the mirrors imparts a high spatial frequency to the phase information. Accordingly, practically all of the phase information is removed by the finite aperture 110 of the projection lens 109-111. (The finite aperture may also be referred to as a Fourier stop.) The result is an image in the wafer plane that is purely amplitude-modulated and therefore behaves in the same manner as an image from a reticle. In particular, since the rows of mirrors on the SLM tilt in alternating directions, there are no telecentric effects (i.e. lateral movement of lines through focus).

In modern bitmap-based mask-writers, the grid produced by the pixels is subdivided by gray-scaling. While not necessarily intuitive, it has been proven by numerous simulations and in practice by the SIGMA mask-writers that the diffractive micro-mirrors can be driven to produce a similar virtual grid function. The rasterizer outputs 64 levels of pixel values, depending on the area of the pixel covered by the feature to be printed, and the pixel values are converted into mirror tilt angles. The resulting virtual address grid is 30/64 nm in a single pass. With two passes the grid can be further subdivided to 30/128 nm=0.23 nm. This is small enough to make the system truly “gridless”. Any input grid, be it 1.0, 1.25, 0.5, or 0.25 is rounded to the closest 0.23 nm. The max round-off error is 0.12 nm and the round-off errors are equally distributed. The resulting contribution to CD uniformity is a negligible 0.28 nm (3σ). Additionally, there are no observable grid snapping or aliasing effects.

The SLM-based image generation system replaces the reticle stage and reticle handler, along with associated metrology, electronics, and software. By synchronizing the loading of image data into the mirror arrays with the firing of laser pulses and wafer stage positioning, the pattern is printed on the wafer. By definition, the mirror array forms a fixed projected grid. Gray scaling is used to control both line width and line placement in sub-nanometer increments. This is achieved by placing the pixel in an intermediate state between “off” and “on” such that only part of the light is transmitted. To obtain good pattern fidelity and placement, the size of the pixel projected on the wafer should be approximately half the minimum CD. With 8 μm×8 μm pixels, the projector system de-magnifies the pixels by a factor of 200 to 300 times. The ultimate stamp size is thus limited by the maximum size of the lens elements close to the SLMs.

In order to achieve high throughput, the OML tool delivers full dose (i.e. energy per unit area) in only 2 pulses per stamp, as compared to 30-50 pulses in a conventional lithography scanner. Due to the small field size, the actual laser power is significantly lower. The data path can accomplish partial compensation for pulse-to-pulse variations, but still a laser with very good pulse-to-pulse energy stability helps meet dose control requirements.

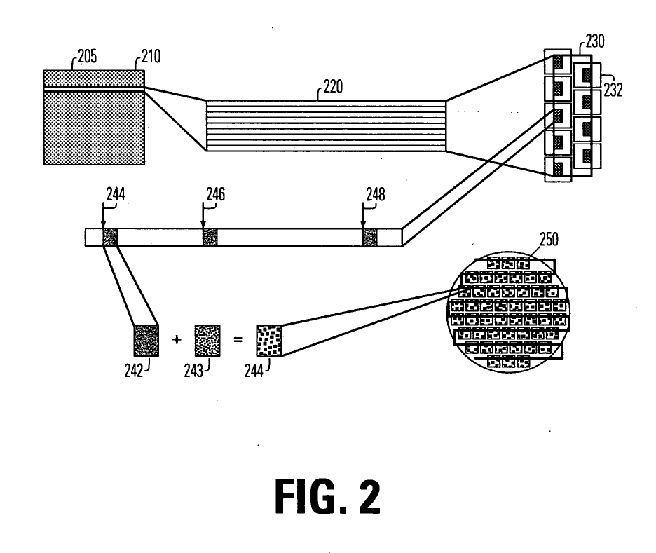

While the wafer is scanning at a constant velocity, short pulse lengths are utilized in OML, making it more analogous to a system that micro-steps from stamp to stamp, as shown in FIG. 2. Stitching quality is therefore a critical performance issue, as both layer-to-layer overlay and within-layer alignment is extremely important. In the figure, pattern data for a die 205 is broken into stripes 210. A strip can be printed by an array of SLMs. The stripe is broken into micro-stripes 220 that correspond to printing by an SLM 232 in the array. The SLMs in the array 230 are loaded with data. The loading of an SLM, 232 to produce a micro-shot 242, 246, 248 and a micro-stripe 220 begins with idealized pattern data 242. Calibrations, corrections and overlap adjustments are applied 243, producing data 244 to be sent to the SLM. The wafer is printed by controlling the sequence 250 of stamps and stripes across all SLMs in the array.

OML Subsystems Overview

Design decisions for OML correlate to throughput and CD uniformity. Throughput is determined by pixel size, number of pixels in one flash, and SLM frame rate, whereas the resolution is affected primarily by the pixel size and the optical design. Secondary parameters include the number of pixels per SLM, stage speed, data flow, etc.

Integrating an Optical Maskless Scanner on an existing ASML TWINSCAN platform means adapting several sub-systems. Most notably, the reticle stage (including interferometry) and the reticle handler are removed from the system. These reticle modules are replaced with a Multi-SLM Array (MSA) module, consisting of multiple SLMs in a pre-defined pattern, along with all of the necessary data-path drive electronics and pattern processing software required to support the use of the SLMs to dynamically generate the required mask pattern. In addition, the laser, illumination system, and projection optics are specifically designed to meet the unique optical requirements of OML.

Accordingly, changes in the form and functionality of the main systems will impact other sub-systems, though generally to a lesser degree. For example, dose control must change because the exposure of the resist is done in only two laser shots and synchronization must be adapted to coordinate the activity of the SLMs in place of the reticle stage.

FIG. 3 outlines the system architecture and the degree of variation between major modules to the system and a conventional ASML TWINSCAN, distinguishing those items that are unique to the OML tool as well as items requiring functional and/or structural changes. A large portion of the architecture can be reused, with major changes to the image generating system and the optical path. The image generation 310 system is adapted from the SIGMA product. A multi-SLM array is entirely new, as the SIGMA product has used a single SLM. Functional and/or structural changes to the SIGMA product are indicated for the remaining subsystems of Image Generation.

Image Generation Subsystem

The image generation subsystem defines the core function of the Optical Maskless Scanner and consists of the SLM unit, driving electronics and data path. Architecturally, it is very similar to the image generation subsystem in the SIGMA mask-writers, though extended to accommodate much higher throughputs as well as incorporating improvements for resulting image fidelity and overlay. The SLM is a VLSI MOEM array of reflective, tilting mirrors, each of which can modulate the reflected intensity and induce phase changes such that, in combination, a geometrical 2D pattern such as a circuit or portion thereof is produced. Since the size of each mirror is several microns, it is necessary to use a strongly de-magnifying projector to reduce the size of the pixels on the wafer in order to print the features of interest. Specifications for one embodiment of the SLM and the drive electronics are provided in the table below.

| Parameter | Specification | |
|---|---|---|
| Mirror Size | 8 μm × 8 μm | |
| Array Size | 2048 × 5120 | |
| Frame Rate | ≧4 | kHz |
| Drive Voltage | <10 | V |
| Number of Analog Levels | 64 | |
| (calibrated) | | |

While ideally one would pack the entire object plane of the PO with a single massive array of mirrors, such devices are beyond current MEMS technology. Thus, it is necessary to use an array of multiple SLMs in parallel to provide the number of pixels needed to achieve the desired throughput. The pixels from different SLMs in the Multi-SLM Array (MSA) are stitched together to form a cohesive picture on the wafer plane using a combination of motion control and gray-scaling techniques. The wafer stage moves continuously, stitching together the distinct SLM images while printing with a set of overlapping pixels along the edges between the SLMs. The layout is structured to allow complete transfer of the pattern with two overlapping laser pulses. Displacing the SLM stamps and pixel grids between the pulses serves to average residual grid and SLM artifacts, thereby reducing any appearance of grid and SLM chip structure.

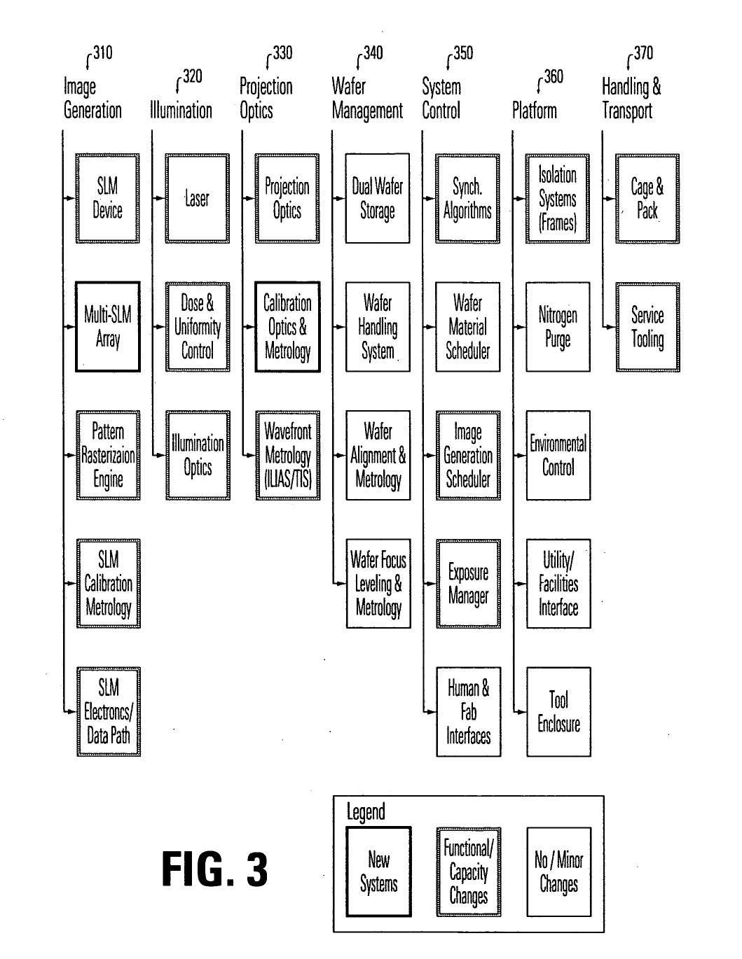

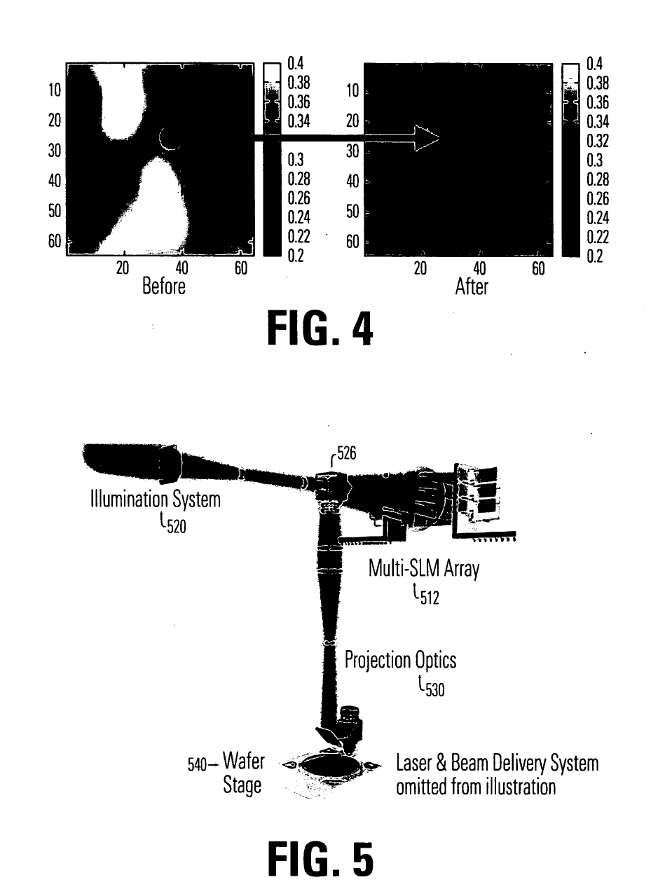

The requirements on mirror-to-mirror uniformity is higher than can be achieved by tight manufacturing tolerances alone. Slight differences in each mirror result from varying film thickness, varying CDs in the flexure hinges, and so forth. Each pixel's response in displacement angle to induced voltage must be calibrated and corrected for with a calibration map that is applied to the bitmap data on a shot-by-shot basis. Gray-scaling for stitching as well as compensation for any bad pixels are embedded in this map. The OML tool calibrates the SLMs in-situ in order to accommodate long-term drift of the SLM pixels. Due to the large volume of pixels and the fact that the projected images of the pixels is sub-resolution, calibration is achieved by looking at groups of pixels and making the group provide uniform intensity at varying intensity levels. FIG. 4 shows the results of calibration of mirrors in an SLM of a SIGMA 7100. These are aerial images in flat gray of an 8×8 array (64 pixels) of an SLM before and after calibration. The leveling effect of calibration is apparent.

Data Path

The data path, together with the analog driving electronics, delivers the data to the MSA with an anticipated data transfer rate of approximately 250 GPixels/sec. The steps for converting pattern data into SLM images to be printed are as follows:

Pattern Input: At the start of a run, the user will upload a mask file (e.g. GDSII or OASIS) into the Optical Maskless Scanner, containing all of the pattern for the die to be printed. The rasterizer is optimized to produce an optical image from the SLM that is as close as possible to the image on a real reticle, with OPC corrections in the input data stream. Even sub-resolution OPC features are accurately represented by the SLM, and the image produced on the wafer is virtually identical to the image from a reticle. Alternatively, OPC corrections can be introduced to the data stream in real time.

Fracturing: Prior to the run, the pattern data is segmented into fragments corresponding to the Multi-SLM Array layout, and sequenced via the writing and stitching strategies to reproduce the pattern on the wafer. This data is fractured to produce a small overlapping border area on each side to allow the fractured images to be stitched during exposure.

Rasterization: During the run, the appropriate image segment for each SLM is converted into a bitmap of pixel values representing the image. The rasterization step includes both processing an idealized image on the pixel grid while maintaining the appropriate feature size and placement, as well as application of corrections and individual mirror calibrations to ensure proper image fidelity on the physical device.

Data Write: The rasterized pattern for each SLM is transmitted to the SLM in synchronization with the laser and the wafer stage, so that the pattern is established on the SLM during the laser flash of the appropriate pulse.

Given the extremely high data flow rates and complex patterns being reproduced, data integrity is an extremely important aspect of the data path. During software development, regression tests can be used to compare against the output of earlier versions.

The second aspect of data integrity is the avoidance of bit-errors in storage and transmission of large data volumes. This is done by standard methods, and since most of the data path works in an asynchronous mode, errors are detected before they can do any damage. In most cases, correct data can either be re-transmitted or regenerated. The system flags all errors, and can be configured to specify the action to be taken on specific types of errors, (e.g. abort the job, abort the die, automatically correct the die, or mark the die as potentially broken in a log file.)

Finally, the high capacity of the data path is achieved through the use of a highly parallel electronic architecture. The downside of parallel systems is the statistically higher risk of malfunctioning modules. Special attention is therefore given to module diagnostics, so that any hardware problems are detected early. With these principles and precautions, the data path will not contribute significantly to yield losses.

Illumination

The illumination system (320 in FIG. 3) for direct writing in a scanner is very different than for a scanner and significantly changed from the illumination system used in SIGMA. Since only a small portion of the total optical field has active pixels, the illumination system must be designed to only illuminate the active pixel areas in the object field. Adaptation to two-pulse printing impacts laser requirements for OML. The power requirements are approximately 1/10 of a conventional scanner, primarily because of the large reduction in field size and a comparatively low throughput. The repetition rate of the laser matched to the refresh rate of the SLMs. A 4 kHz laser can be used. Pulse-to-pulse stability of 1% 3σ is helpful, which is roughly 10× better than conventional lithographic lasers that use pulse averaging of 30-50 pulses for dose uniformity. Alternatively, additional pulses can be used to deliver the dose with more averaging, and can be set to correct dose errors from previous passes. While these alternatives can improve dose control, they reduce throughput.

Laser pulse timing error (i.e. jitter) also can impact overlay performance. In a conventional scanner, the wafer and reticle stages run synchronized, so laser timing and pulse length do not significantly influence pattern placement. In Optical Maskless Lithography, as the SLM array is “stationary” during exposure, i.e. the image is scanning at the speed of the wafer stage. For wafer stage speeds on the order of 300 mm/sec, a 30 nsec laser timing jitter results in a 9 nm placement error, which is unacceptable for some applications. The duration of the pulse will result in a smearing of the image, though this smear effect is constant for a constant wafer stage speed and is therefore not a concern for overlay. Furthermore, the impact of smear from a relatively short pulse duration on X/Y asymmetry is easily corrected in the data path.

The table below summarizes desired laser characteristics.

| Parameter | Specification | |
|---|---|---|
| Wavelength | 193.368 | nm |
| Bandwidth | 10 | pm |
| Static Range | 193.33-193.45 | nm |
| Rep Rate (max) | ≧4 | kHz |
| Power | ≧5 | W |
| Pulse Energy | ≦10 | mJ |
| Pulse Length | ≦20 | ns |
| Pulse Energy Stability | <1% | 3σ |
| Pulse Jitter | <5 | nsec |

Dose measurements use a sensor in the illumination system to track the intensity of each pulse. Power tracking with such a detector is useful in an OML scanner, averaging over just a few pulses, as dropped pulses or large pulse-to-pulse variability can have a significant impact on tool performance. Dropped pulses are easily detectable—by tying the detector into synchronization such that each sync pulse has a corresponding energy reading, tool software can readily confirm valid detector readings for each pulse. The 193 nm illumination energy detectors used in ASML scanners track energy per pulse. These detectors are calibrated between wafers to an energy detector on the wafer stage, which in turn is referenced periodically to a global standard with a removable master detector.

The illumination optical design concept is based upon a multi-array design providing pupil and field definition, along with multiple condensers to provide illumination homogeneity. This concept allows OML to generate the same illumination profiles and sigma settings as conventional scanners. The advantages of the multi-SLM array design may include:

Field Definition—This design allows for a field-defining element (FDE), so that only the active mirror portions of the SLM in the Multi-SLM Array are illuminated. This is needed to improve the stray light characteristics of the system and to allow for lower power, since only a small portion of the optical field area for the Multi-SLM Array contains active pixels.

Pupil Polarization Support—Primarily for extendibility to future lithography generations, the multi-SLM array design allows for polarization of the pupil for enhancing certain feature types in ultra high-NA systems.

Projection Optics

Among the projection optics 320 subsystems, Calibration Optics & Metrology are very different from the subsystems used in SIGMA. A catadioptric design form with a beamsplitting cube 526 has been identified as a useful design for OML, due to its optical suitability for the 65 nm node as well as potential extendibility to next-generation requirements. This design reduces the amount of glass used, and does not require significant quantities of CaF2. The preliminary optical design for the projection optics is shown in FIG. 5. The illumination system 520, multi-SLM array 512, projection optics 530 and wafer stage 540 are illustrated.

Multi-SLM Array

The mechanical mounting and the electrical and optical packaging of each SLM are part of the design of the Multi-SLM Array. Since accurate control of the spacing between the active portions of the SLMs is needed to achieve proper stitching between the images of individual SLMs, the packaging must be designed so as to accommodate the desired SLM layouts.

The extension of SLM technology to print directly on wafers presents unique challenges. The system specification on throughput, along with the requirement to provide two-pulse printing, drive the need for ˜60 MPixels per laser flash to be printed. At 4 kHz operation, assuming each SLM consists of an array of 2048×5120 active mirrors, 6 SLMs are required in the object plane of the projection optics. Limits on the maximum feasible lens diameter in front of the SLM, along with packaging and spacing requirements to ensure proper stitching of discrete SLM images while printing, impact the layout of the SLMs in the optical field.

Configuring the multiple SLMs to satisfy optical, packaging and servicing issues presents optical, electrical, and mechanical tradeoffs. In addition, the electrical design supports data transfer rates in excess of 250 GPixels/sec in order to write data to each of the SLMs at a 4 kHz refresh rate. Since the current SLM design does not contain on-board digital/analog converters, each SLM is driven with analog signals. Accordingly, each SLM needs ˜1,000 DACs and amplifiers next to the chip and ˜2000 coax electrical wires to drive the amplifiers.

Existing Systems

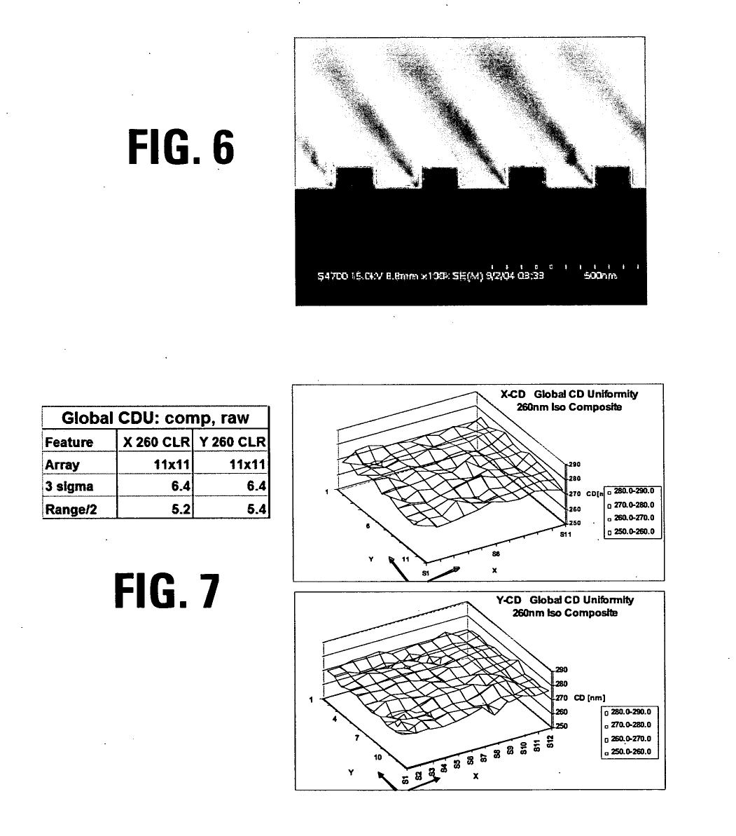

The feasibility of using the tilting mirror architecture for lithography is confirmed by recent results from the Sigma 7300 mask writer. Shown in FIG. 6 is a dense 150 nm line/space pattern in chrome. This pattern was written on FEP 171/NTAR 7 blanks.

FIG. 7 shows composite CD uniformity for an 11×11 matrix over 121 mm, the current performance of SLM lithography using the Sigma 7300 with 80 nm projected mirrors. In a 65 nm-node maskless tool they would be 30 nm. Most SLM-related errors scale with the pixel size.

A new mirror design with a 180 degree phase step has recently been presented as a way of creating the analog of strong phase shifting. This disclosure describes various properties of the new tilting phase-step mirror and shows an example of the sort of data path needed. It also gives examples of how a phase-step mirror tilting or piston) could be used in an optical maskless system.

The Complex Amplitude

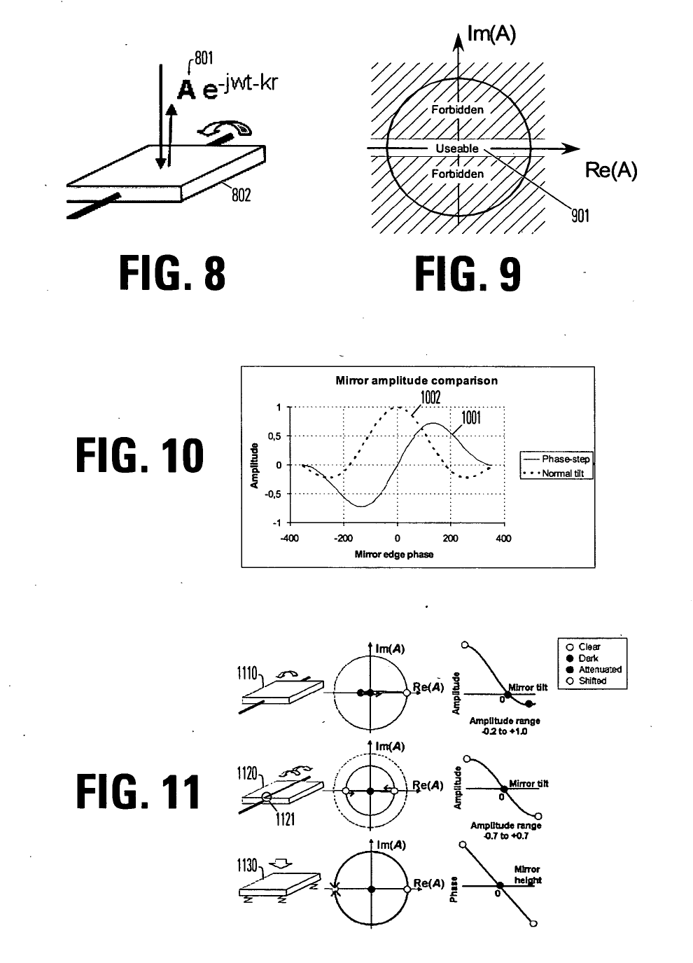

Analyzing different mirrors is most suitably done in the complex plane where the complex amplitude of the reflected light is A (801) as defined in FIG. 8. The partially coherent reflected light from a tilting micro-mirror 802 can be obtained by integration over the deflected surface for a given tilt:

$$A = {∮}_{S} r ( x , y ) \cdot {ⅇ}^{\frac{- ⅈ4π h ( x , y )}{λ}} ⅆ x ⅆ y$$

where S is the surface of the mirror, λ is the wavelength and h is the local height. The relation between Re (A) and the position of an edge is not necessarily linear, but still a monotonous function. The square of the modulus of A, namely the intensity, is not even monotonous and thus less suitable as a means of analysis.

In principle the whole complex plane is available to SLMs, but for lithography, all areas except a narrow band along the real axis 901 are impractical to use, FIG. 9. All reticles in practical use have the transmitting areas on the real axis, and moreover they have tight tolerances on the phase angle. The reason is found in the properties of the Fourier transform. All real functions have symmetric transforms and vice versa. If the function is not real and the transform not symmetrical, the center of printed features will shift through focus. The square of the modulus of the transform is the light distribution in the aperture plane, and if the light distribution is skew we have what is improperly referred to as non-telecentricty or a non-vertical landing angle in ebeam vernacular. Asymmetry in the aperture plane gives feature shift through focus.

Tilting Phase-Step Mirror

The new micro-mirror design, the “phase-step mirror”, looks surprisingly similar to the flat tilting mirror considering the high amount of improvement it constitutes. The only difference in design of a phase step mirror compared with an ordinary tilt mirror is a height step in the middle of the reflective surface. The phase step cancels the amplitudes from the two mirror surfaces and results in no intensity (black) for the non-deflected state. Tilting the phase-step mirror one way gives an amplitude trajectory in the positive real amplitude direction up to an amplitude of about +0.7. Tilting the phase-step mirror 1002 the other way gives reversed negative amplitude of −0.7, as depicted in FIG. 10. This figure depicts the real part of the complex integrated amplitude versus the phase angle (in degrees) at the edge of tilting mirrors 1001, 1002. This means that an SLM with phase-step mirrors requires twice as much dose as an SLM with normal tilt mirrors, but then it gives access to strong phase shifting of ±100% amplitude with preserved gray scaling. In contrast to normal scanners the maskless scanner is not through-put limited by the amount of light, so the loss in optical efficiency has no serious consequences.

The required tilt angle for the full address range (white to black) is also reduced for the phase-step mirror compared with the normal tilt mirror. A normal tilt mirror requires a deflection that shifts the phase by 180 degrees (90 degrees in reflection) at the mirror edge while the same requirement for the phase-step mirror reduces to ˜130 degrees (˜65 degrees in reflection). The amplitude versus edge phase (tilt) behavior can be seen in FIG. 10. From this figure it is also apparent that the accessible negative amplitude is limited for the normal tilt mirror 1001.

FIG. 11 illustrates three types of mirrors and their trajectories through actuation: a tilting flat mirror (central axis) 1110, a tilting phase-step mirror 1120, and a piston mirror 1130. The tilting flat mirror 1110 is bright when flat. The range of reflected phase is from 0 degrees when flat to +/−180 degrees when tilted. The intensity of the reflected radiation is in the range of −0.04 to +1. This type of mirror behaves like an attenuated phase shift mask.

The tilting phase shift mirror 1120 is dark when flat, as one side at a quarter wavelength, λ/4 height difference 1121 provides a 180 degree phase shift. The range of reflected phase is from 0 degrees when flat to +/−180 degrees when tilted. The intensity of the reflected radiation is in the range of −0.5 to +0.5. This type of mirror behaves like an alternating phase shift mask.

The piston mirror 1130 is described differently. It does not pivot, so the phase across the mirror is uniform and directly related to the mirror height. Each mirror is always flat and bright, with intensity controlled via phase interference between neighboring pixels. The intensity range is −1.0 to +1.0. This type of mirror behaves like an alternating phase shift mask.

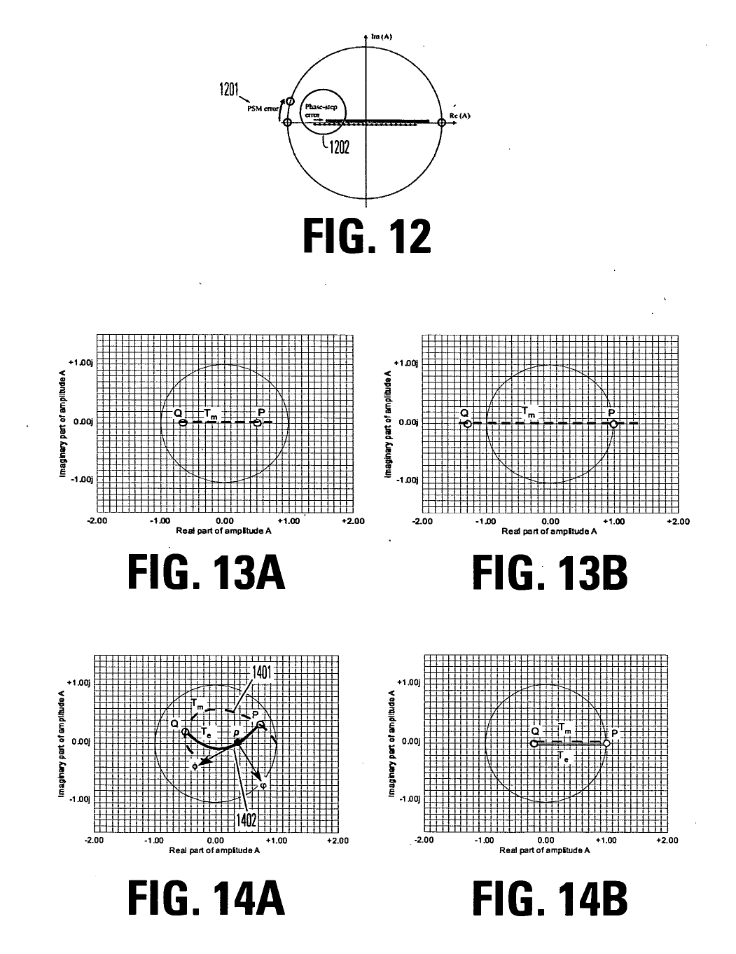

An important observation regarding the phase-step mirror is that it is fairly insensitive to step height error. This is illustrated by FIG. 12. An alternating phase shift mask has tight specifications for the phase shift magnitude since an error in phase shift adds imaginary amplitude 1201 to the image in the stepper. It turns out that the phase-step mirror has much less strict requirements concerning step height accuracy. The reason is that a step height error manifests itself as a shift of the complex amplitude trajectory in the real direction 1202. This effect does not degrade the writing performance but simply constitutes a slight shift in the grayscale that can be removed during the SLM calibration. The figure illustrates differences in errors from a PSM mask with a phase error 1201 and from a tilting phase-step mirror with a step height error 1202.

The phase-shift mirror uses the same CMOS circuit and the same mechanics as the flat tilting mirror. The main difficulty is the fabrication of the mirror with a very flat reflecting surface, but with half of it raised by 180 degrees.

Going Outside of the Unit Circle

The amplitude A in the complex plane is a phasor representation of the electric field. If the exposure dose is increased the phasor grows and could fall outside of the unit circle. Obviously the scaling of A is a matter of convention and we need to define a scaling rule in order to avoid miscommunication:
Scaling rule: “Clear is always 1.00+0.00j”

The scaling rule also takes care of another problem of reference: rotation of the complex plane. If the distance between the SLM/reticle and the work piece is changed the figure in the complex plane rotates around the origin. The reference A=1.00+0.00j fixes the rotation as well. This scaling rule is of course nothing new; it is implicitly used by all lithographers already, but the availability of continuously variable transmissions makes an explicit rule necessary.

FIG. 13a shows an SLM mirror driven along the trajectory during actuation Tm between two states P and Q, where P is clear and Q is shifted. The modulus of Q is larger than the modulus of P. FIG. 13b shows the same mirror at a higher exposure dose than in FIG. 13a. In reality both have reflection coefficients well below 1. The dose in 13b is set according to the scaling rule and makes P=+1.00+0.00j and Q=−1.30+0.00j as shown in FIG. 13b. The relevance of equivalent transmissions larger than 100% will be shown in an example further on.

Rasterization

Rasterization from vector input to a multi-valued (“gray-scale”) bitmap is used in printing, computer graphics and also in incoherent pattern generation, both for raster ebeam and laser scanning. Micronic's SLM lithography is different in a fundamental sense: the mirrors don't control the intensity but the complex amplitude of the reflected light. After Fourier filtering the high frequencies that contain the phase information are removed. The remainder is not intensity modulation, but modulation of the real part of the amplitude along the real axis in the complex plane. The conversion to intensity is done in the square-law detector, i.e. the resist and/or diagnostic cameras. To make a distinction between the real-valued amplitude modulation and the intensity modulation used in raster-scanning pattern generators may seem like a play with words, but the physics is demonstrably different. The local image properties are determined by the interference of amplitude contributions, not by the superposition of intensity. The benefit of working in the amplitude domain is that the amplitude is a more powerful quantity than the intensity, e.g. one amplitude contribution can cancel another one so that they together produce darkness. This is of course how alternating-aperture PSMs work.

The surprising fact is that, even though the physics is different, the rasterizer for tilting mirrors is similar to the ones used for incoherent or intensity imaging. The fact has been revealed by extensive analytical work and testing of Sigma systems. The interpolation for the virtual grid or for printing of features smaller than a single pixel is analogous to that used for incoherent images. This can be explained by a thought experiment shown in FIG. 14. Assume that we design a side-tilting mirror to be used in a pattern generator. The mirror which is shown in FIG. 14a has a trajectory Tm that starts at 1.00+0.00j and follows a curved path 1401 spiraling in towards the origin (this is actually a typical curve for an edge-hanged tilting mirror). We select two points P and Q on the trajectory as clear and shifted areas. The mirror can represent these points accurately. Now we calculate, e.g. by use of a commercial simulator, what complex amplitudes are needed on a pixel located at the edge to place the printed edge at all intermediate positions. This traces a new trajectory 1402, the edge trajectory Te. In a general case, Tm and Te will not be parallel and a single mirror cannot represent the movement of the edge. For each point p on Te there is a direction φ that affects the edge position directly and a perpendicular direction φ which affect the stability through focus. The difference between a desired point p on Te and a chosen approximation on Tm is an error, typically a shift through focus.

Now look at FIG. 14b where we have the two areas P and Q on the real axis. The mirror is a central axis tilting mirror, which preserves the phase through actuation, i.e. it traces a straight line Tm along the real axis. The correct trajectory for edge-location interpolation Te between two real points is also a straight line. This can be seen from symmetry: The trajectory from 0.00+0.00j to +1.00+0.00j has to be real since in a symmetrical optical system there is nothing that favors a positive phase over a negative one.

Any interpolation between the two real values P and Q in FIG. 14b representing the two sides of the feature boundary lie on the real axis and can be reached by the tilting mirror. Therefore the tilting mirror can represent any line pattern correctly. The same argument can be extended to 2D patterns. The conclusion is that the central axis tilting mirrors support a scalar rasterization scheme where each mirror is treated separately and do not need to work collectively with its neighbors.

Inversely, since other mirror types trace a curved path in the complex plane, a single mirror cannot create the correct interpolation and these other mirror types must be used in clusters.

In intensity (or incoherent) imaging, the intensity is a real-valued positive scalar, i.e. a one-dimensional quantity, and interpolation is always along the single scalar dimension. This similarity between incoherent imaging and partially coherent imaging with tilting mirrors makes them work with similar data paths.

A detailed study of the partially coherent case shows that the square-law detector causes significant non-linearity between edge placement and intensity. In the general case, neither intensity nor amplitude is linear with edge placement, and a correction for the non-linearity is needed. This is included in the SLM calibration and voltage look-up scheme. With the addition of this look-up function that is calibrated for the coherent non-linearity of the system, a simple rasterizer can be used. This explains why data path architectures normally used for incoherent systems work for SLM lithography with tilting mirrors.

The mathematically inclined reader would note that the points on Tm and Te in the complex plane form a convex subspace. This means that any point on a straight line between two points in the space is also inside the space. This argument does not depend on which points are chosen. Whatever tones we assign P and Q to, all intermediate points are reachable and the benign rasterization properties remain the same. Only the non-linear look-up table changes depending the selection of P and Q.

The simplifications that follow from what is described above are immense: data can be rasterized by an explicit algorithm and one pixel at a time. The data path can use adapted versions of proven architectures such as those used in graphic processors for video displays. It can be expected that proven image processing algorithms work at least approximately. For a maskless system with a pixel rate of 250 billion pixels per second it is paramount that the rasterization be explicit, predictable, and efficient.

The second benefit from the scalar pixel processing is that interactions between the rasterization algorithm and the pattern are not likely to occur more than in any digital camera or computer-graphic display. This is consistent with the experience from the Sigma maskwriter: the rasterizer is essentially error-free for arbitrary patterns, apart from round-off errors which are reduced to insignificant levels by design. The processing also has a constant processing rate independent of the pattern up to a (high) limit, where excessive numbers of redundant or overlapping data elements may cause it to choke.

Grid Filter and Edge Enhancement

As explained above, the architecture and pattern representation for the tilting mirrors has been found, after extensive research, to be similar to those in ordinary image processing and algorithms similar to those used in digital photography are used to improve the image quality above that of the pure SLM. The SLM image is of high quality and not degraded by a mask process or by electromagnetic effects thanks to the high demagnification (>100×). There is a specific loss of edge acuity from the use of intermediate values for placement of the edges, though. The image log-slope is lower when an edge falls off the mirror grid than when it falls on it. For small features the contrast suffers and CD through grid gets a second-order contribution from this effect. Since in a maskwriter or maskless tool the edge cannot be predicted to fall on the grid this is undesirable. Hans Martinsson et al. have shown that the grid effect can be removed by a digital filter that adds contrast to those edges that fall off the grid. When the filter is tuned to give the same Fourier transform between on and off grid positions the printed image is identical to the corresponding reticle image. We call this the grid filter.

Edge enhancement is another digital filter that essentially raises the contrast on all edges by applying a derivating kernel to the bitmap. Edge enhancement can give contrast of small features a boost that is not available with physical reticles. Furthermore it improves NILS and CD control on all features. It raises the edge acuity and reduces the quality figure (nm CD/% dose). Since this figure is a multiplier in almost all terms of the CD budget from laser noise to processing the effect on over-all CD control is significant.

The variable corner enhancement in the Sigma 8300 is another example of the robust properties of bitmap processing and tilting mirrors. An “Adjustment Processor” after the rasterizer finds the corners in the pattern and adds subresolution serif-like gray-scale modifications. The result is corners that can be tuned from rounded through sharp to protruding, so that a good match with a target variable-shape ebeam writer can be calibrated, or indeed detuned to match a less sharp laser PG. The enhanced corners, although the added corrections are not even proper features, print stably through grid and focus.

Data Path For Phase-Shifting

How much of this can be retained with phase-shifting? The surprising and counter-intuitive answer is “Nearly everything!” The picture drawn in FIG. 14b with the mirrors modulating the complex amplitude along the real axis still holds even if the modulation extends further into the negative side. The interpolation between any two PSM values along the real axis is the same, although the non-linear look-up function changes with illumination setting and choice of PSM mode. The image-processing algorithms still work in phase-shifting patterns, and the grid-filter and edge enhancement can also be used with phase-shifting patterns.

A useful function is a dark frame, such that all pixels outside of a specified coordinate print calibrated black, regardless of the settings of P, Q, R, and S. Four values of gray can be printed, without black counting as one of the values. This function is used to trim the exposed field when none of the tones is really black. This is comparable to the chrome frame on an embedded PSM.

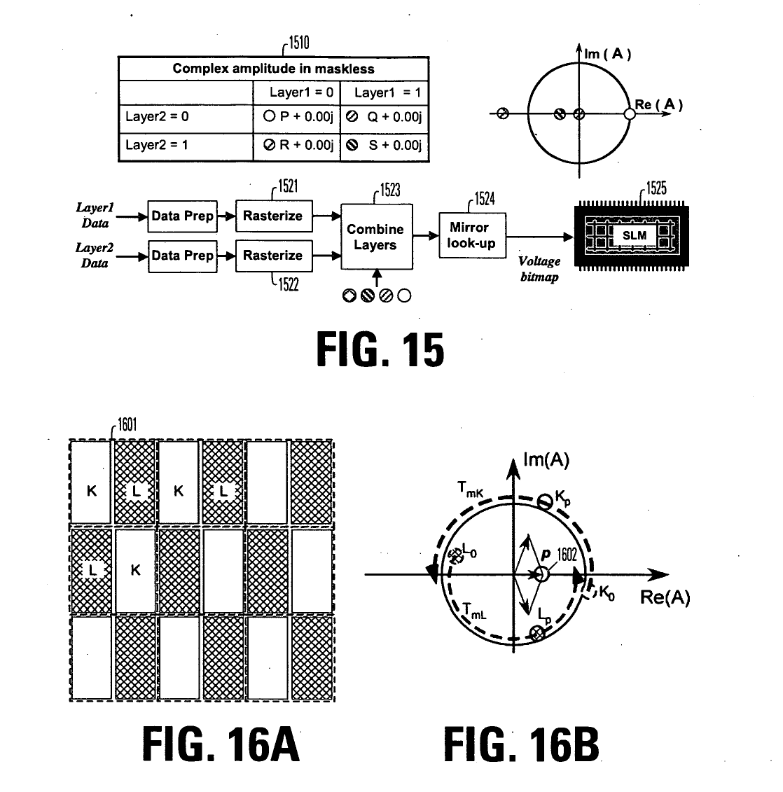

FIG. 15 depicts a datapath that drives four arbitrary real tones 1510 based on combination of two layers. The patterns files specify the pattern. The tones can be input as job parameters. Layers are combined after being rasterized individually. Dual data paths independently rasterize the data 1521, 1522, which is combined 1523 before the data is fed to the look-up table 1524 process and used to drive individual mirrors of the SLM 1525. More than four real tones can be used by expanding from a dual to a triple or more extensively parallel datapath. Depending on the buffer memory available, the dual datapaths may operate more or less in parallel. The datapaths are substantially in parallel if they can use volatile buffer memory The data requirement to drive these SLMs can be met by a pipelined architecture using volatile memory for buffering, thereby avoiding the limitations on the speed of rotating memories.

Comparison To Piston Mirrors

Development of mirrors in the mid 90ies began with mirrors that had the hinged at one end of the plate. When actuated, they became darker but also changed the phase angle, like the trajectory shown in FIG. 14a. The result was that off-grid edges printed as if they were out of focus. The two edges of a feature would appear as if the edges were formed by metal films at different heights above the SLM. The remedy was to move the hinge to the center of the mirror so that areas advancing the phase balanced areas retarding it. This scheme has worked extremely well. The phase-step mirror is a way of extending this well-functioning principle into hard phase-shifting.

Piston mirrors have the same property as the end-hanged ones: the phase varies when they are actuated. In fact they are the exact opposite to the tilting mirrors: the phase varies, but not the modulus of A. Therefore pistons must always act collectively: one piston must act to cancel the phase of its neighbors. There are two conditions to be met at the same time: zero combined phase and the combined modulus given by the pattern. It is difficult to see how this can be done at all for general 2D figures and subresolution features unless the mirrors are significantly smaller compared to the resolution of the optics. The result is smaller mirrors than for the tilting mirror case, many more of them, and a more complex CMOS circuit with higher bandwidth driving requirements. Furthermore, the rasterization per pixel is much more complex and probably more akin to model-based OPC than to raster processing.

One way to use piston mirrors is a piston/tilting hybrid: make the pistons with an aspect ratio of 2-1 and use them in square pairs, FIG. 16. Within each pair (K & L) 1601, the two mirrors would always take opposite phase angle and thus the pair would give real-valued amplitude, as shown in FIG. 16b. This would solve the rasterization issue, since such a piston mirror SLM would work with the same rasterization as the tilting step-mirror. Mechanically, such an SLM would need a longer stroke, 0-360 degrees instead of 0-180 for the phase-step mirror. The relative precision in the movement would have to be better in the piston mirror for the same printing specifications to be fulfilled and the stability would need to be higher. The needed stroke and precision could be reduced to 180 degrees if every second mirror were raised by substantially 180 degrees in the non-addressed state. The non-addressed state is practically achieved by calibration, to compensate for manufacturing variations. A difference in reflected phase of 180 degrees corresponds to a measured height difference of a quarter wavelength. The alert reader notes that this is in fact a double-piston implementation of the tilting phase-step mirror. It is brighter than the tilting phase-step mirror, but the same numbers of mirrors only give half the throughput as with tilting phase-step mirrors. The piston hybrid is more sensitive to errors and it has similar manufacturing issues as the phase-step mirror.

Bestiary of SLM Lithography

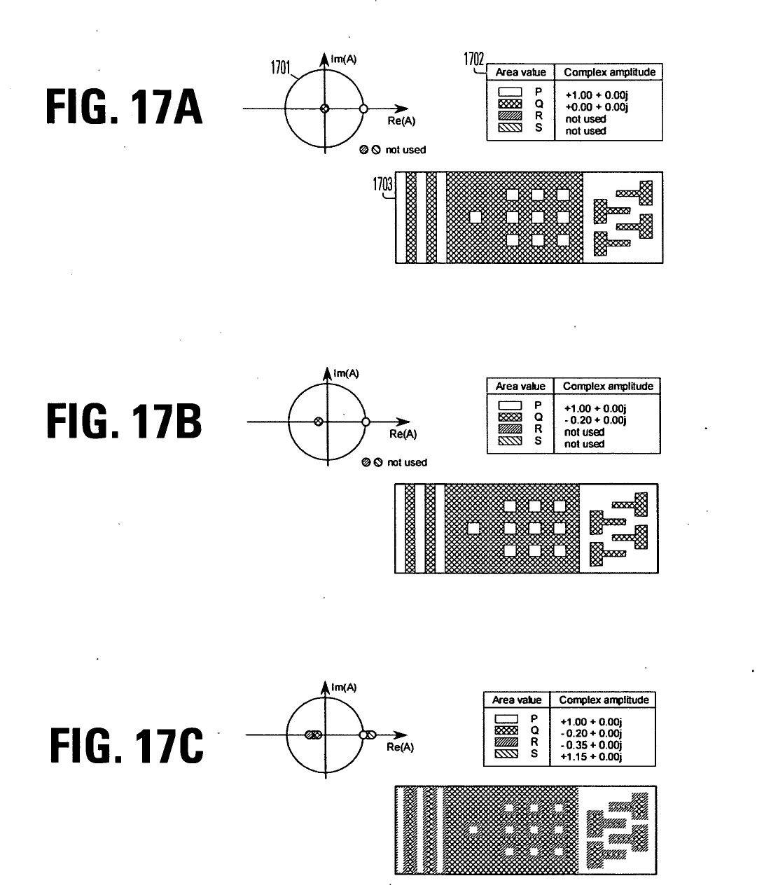

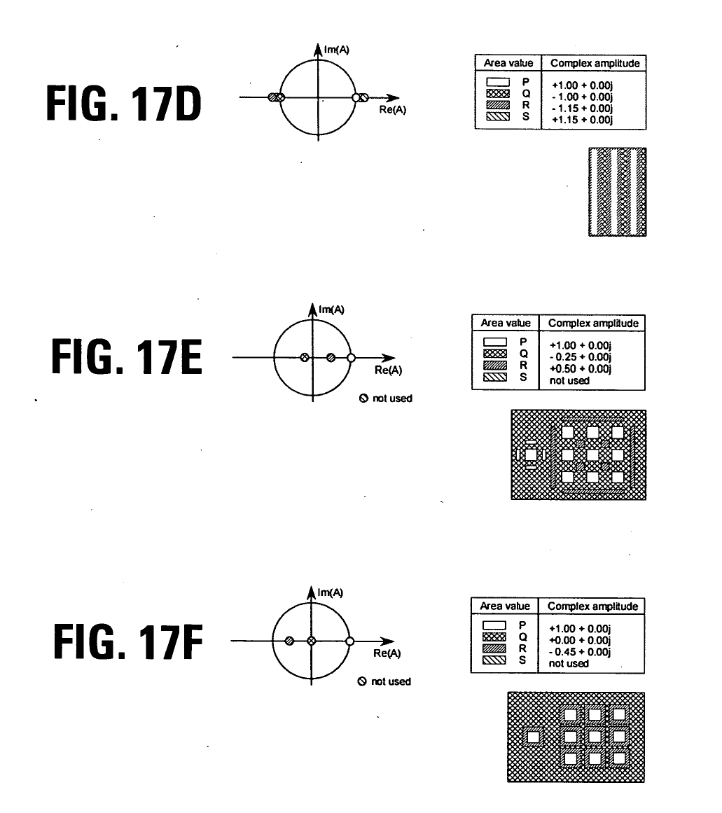

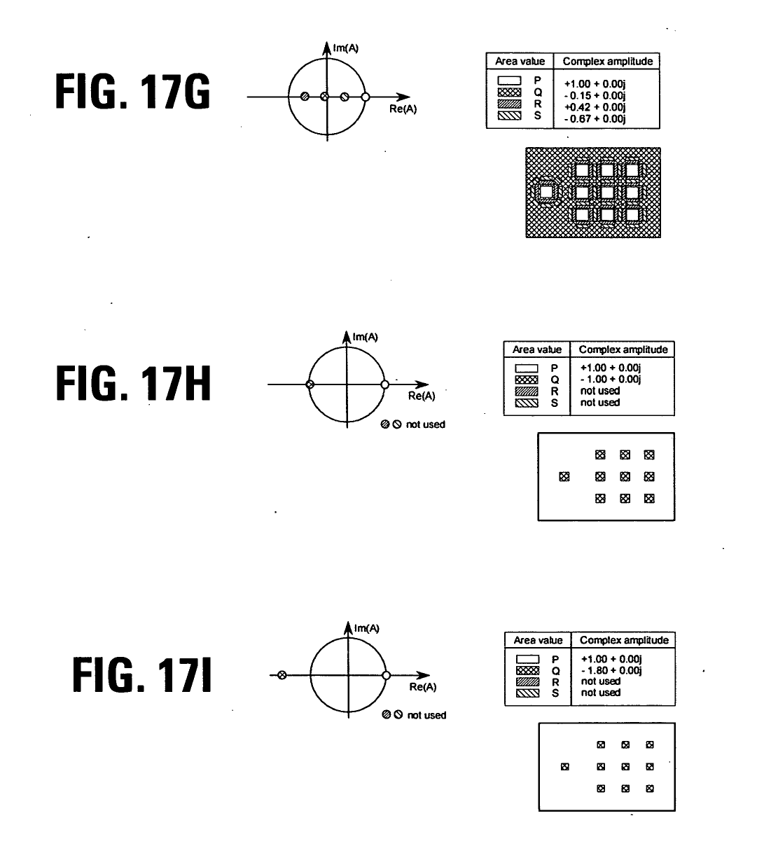

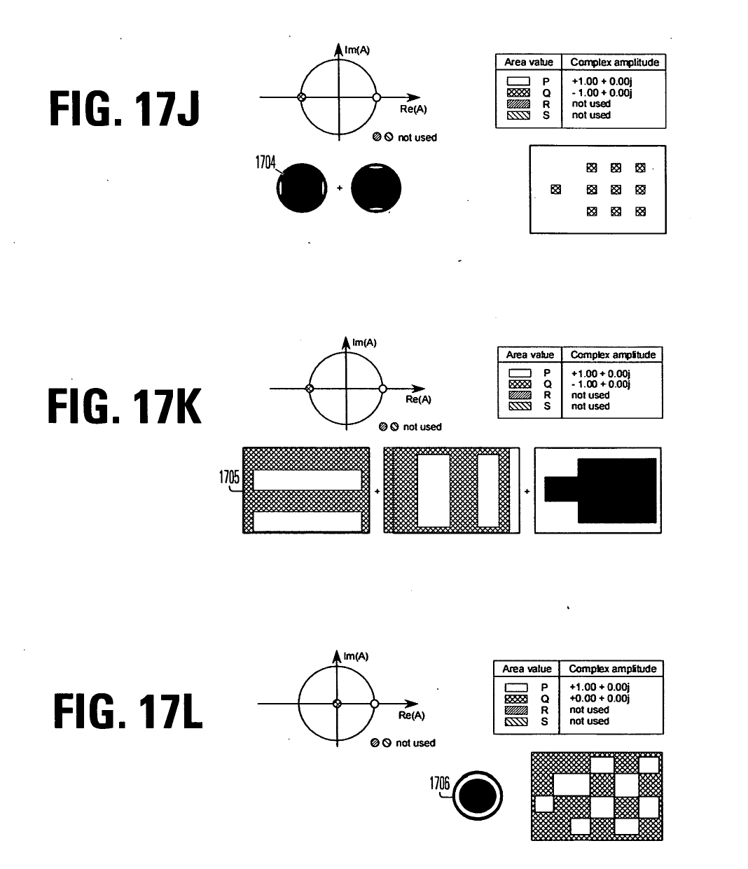

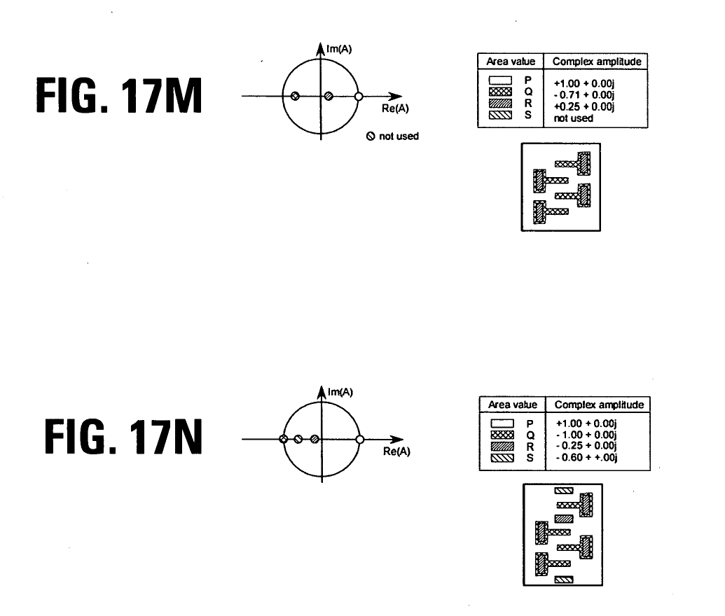

The continuously selectable tones, multi-exposures and edge processing give large flexibility for different lithographic schemes, some of them emulating phase shifting masks, some of them entirely new to OML using SLMs. FIGS. 17a-17n show a compilation of examples on how the proposed SLM and data path could be used. Each illustration shows the table of used tones in a 4-code data path, where the tones fall in the complex plane and a piece of a relevant pattern. The examples are conceptual, therefore the patterns and the stated amplitudes are indicative and subject to refinement.

FIG. 17a depicts emulating a binary reticle with clear and black portions. A single datapath is used.

FIG. 17b depicts emulating an attenuating PSM, generating negative black amplitudes. A single datapath is used.

FIG. 17c depicts emulating a mask system that generates four gray values. This arrangement adds negative black and edge enhancement to what a binary mask can generate. For this and FIGS. 17d to 17g, dual datapaths are used, sometimes with three gray values and other time with four.

FIG. 17d depicts emulating a pair of alternating aperture PSMs, which generate four gray values. This arrangement affords edge enhancement.

FIG. 17e depicts generating assist bars and features to control sidelobes using an intermediate tone.

FIG. 17f depicts edge enhancement using a high-transmission three-tone pattern. The third tone can be selected to optimize results.

FIG. 17g depicts an interference mapping application, as described in U. Ljungblad, H. Martinsson and T. Sandstrom, “Phase Shifted Addressing using a Spatial Light Modulator”, MNE (Micro- and Nano-Engineering) 2004 Proceedings. Optimal tones have been selected.

FIG. 17h depicts a chromeless phase lithography (CPL) application for printing contacts on negative resist. For this and FIGS. 17i to 17l, a single datapath is used.

FIG. 17i depicts a CPL contact pattern for negative resist using a so-called “super-shifter” having a large negative amplitude. The approach prints with less iso-dense bias than same pattern in FIG. 17h, printed with a normal shifter having less negative amplitude.

FIG. 17j depicts printing a CPL contact patter for exposure with horizontal (H) and vertical (V) dipole illumination. This approach prints very dense (small) contact points on a negative resist.

FIG. 17k depicts three pass printing of an array of contacts on negative resist using crossed phase edges (H+V) and a trim mask.

FIG. 17l depicts a so-called “real vortex”, a vortex-like pattern using only real tones. The phase edges do not print under with a wide annular illumination; the singularities give stationary dark cores.

FIG. 17m depicts gate printing application using CPL. Dual datapaths are used.

FIG. 17n depicts using CPL to print gates, with partial tone sub-resolution assist figures (SRAFs), for critical dimension (CD) enhancement through pitch.

Additional examples are given in the provisional applications that are incorporated by reference, U.S. Provisional App. No. 60/610,012 filed 15 Sep. 2004 and No. 60/615,88 filed 4 Oct. 2004, both filed by the same inventors under the same title as this application.

Pattern Decompositions

One of the most powerful methods to improve the performance and utility of the maskless scanner is by pattern decompositions. Since the same wafer is exposed again with a different pattern and/or a different machine setting and without reloading either the wafer or reticle, the overlay between the passes is near to perfect.

Horizontal-vertical decomposition, with varying polarization and/or illumination, possibly varying pupil filter and Zernike aberrations as well. The composition can of course be done in other directions as well, such as slash-backslash (45-135 degrees), e.g. in metal interconnect layers.

Pitch decompositions, e.g. to avoid forbidden pitches, to avoid printing isolated features, or to divide a dense pattern into two semi-isolated.

Trim-mask schemes: phase-edges plus trim mask,

Crossing phase-edges for contacts on negative resist

Resolution of phase conflicts by multiple exposures with the phase conflict moved between the passes. It is further possible to compensate with extra exposure in one pass on top of the low exposure from the phase edge in another pass.

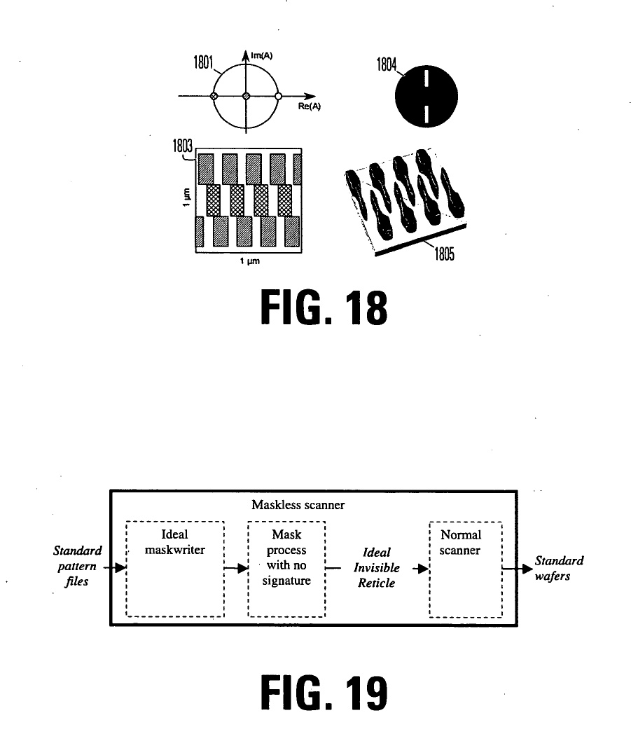

Resolution of phase conflict by having highly different sigma in x and y, FIG. 18. x and y phase edges printed in separate passes with 0 and 90 illuminator angles.

Swap between clear and shifted areas in AA-PSM patterns between passes for better symmetry.

It is sometimes possible to mimic a reticle with a larger number of tones by double-exposure with two different sets of tone values.

Many other corrections can be done in a later corrective pass: dose, overlay, drift during the previous passes, delay effects, process variations, stray light. In principle it is possible to measure the latent image, e.g. by scatterometry, and correct it in a corrective pass.

FIG. 18 illustrates formation of gate-like structures in a single pass by phase edges. The phase edge on the short side of the shifter does not print due to the low coherence in the vertical direction. The pitch depicted is 130 nm, with a gate linewidth 45 nm, using 193 nm dry exposure and a NA=0.93. With two exposures, both x and y-oriented gates could be printed.

The list above enumerates decompositions of the entire pattern, but another important option is to decompose the chip by area and write each area by itself:

Logic vs. embedded memory

Logic vs. analog, RF, optical, high-voltage, etc

Constant vs. variable part, e.g. a metal layer with some personalization

IP blocks with different lithography assumptions

Areas written in different numbers of passes

Areas with different focal planes, e.g. in MEMS and SoC devices.

EDA Software

As has been shown above the developed maskless architecture uses existing infrastructure for physical layout, both file formats and OPC models. The structure of the mirrors is hidden inside the rasterizer and SLM modules and appears neither in the printed pattern nor in the data. CD and NILS of a feature are independent of the placement relative to the grid and, if the user so chooses, identical to the image from a reticle. The conceptual model is that the maskless consists of a normal scanner, an ideal maskwriter and an invisible reticle made and consumed inside the system. In terms of how the system interacts with the external world, this notion could be considered to be literally true: the system accepts standard pattern files and the printed image is the same as that from a standard scanner or stepper, as depicted in FIG. 19.

The quality of the invisible reticle, as judged from CD linearity and corner rounding on the wafer, has been shown to be superior to physical reticles. This is why we claim that the embedded maskwriter can be considered to be perfect. Furthermore, the “embedded mask process” is not only perfectly neutral, it does not even exist.

The conclusion of the discussion above is that no special EDA software is needed for the maskless system. On the other hand there are a multitude of new opportunities for “LithoPlus” operation using bitmap processing, seamless multi-exposure and the continuously selectable tones. There is an opportunity for EDA companies to exploit these schemes with special software. In particular the designer will need maskless-aware OPC/PSM engines that allow optimization of patterns with selectable tones and pattern decompositions into multi-exposures with different optical settings in order to make best use of the new technology.

In principle it is possible, either in the OPC step or by bitmap processing to downgrade the writing properties to match a particular mask technology (maskwriter, process and mask type). For example polarization effects in the reticles may be added as a boundary-layer correction.

New Rules for Lithography with Phase-Shifting Maskless Technology

1. With the grid filter SLM lithography can always match a reticle in resolution and surpass it in fidelity

2. With edge enhancement the SLM can print smaller features with higher contrast and better CD uniformity

3. Reticle defects don't exist

4. Reticle polarization effects don't exist

5. EMF and aspect ratio effects on the reticles don't exist

6. Reticle process loading does not exist

7. The patterns are not limited by the maskwriter resolution

8. The patterns are not limited by available blank transmissions

9. The patterns can have multiple tones

10. The patterns are not limited to the unit circle

11. There is no cost issue with aggressive OPC or phase-shifting

12. There is no lead-time issue with aggressive OPC or phase-shifting

13. There can be multiple designs and design variants on a single wafer

14. The patterns can be decomposed at will with no quality loss

15. Phase conflicts can be resolved

16. CD errors can be reduced arbitrarily by multiple passes

17. Multiplying the number of passes increases the exposure cost linearly, but it does not affect fixed cost like it does with reticles.

Discussion

Maskless tools have mostly been discussed on the merits of cost saving, possibly on lead-time reduction. But one can argue that its highest value is for the creation of new information and speeding up learning. The information that a design works is more valuable than the prototype circuits them. One of the authors happened to visit De Beers' central laboratory, and was surprised that the most guarded objects in the plant, hidden inside a special keep with barbed wire, TV cameras, and intrusion sensors, were not the diamonds but the plastic bags with soil samples. Information is more valuable than diamonds. “The only sustainable competitive advantage is the ability to learn faster than the competitors”. In this case the main enemy may be more the complexity of modern lithography than other companies.

The described architecture can, within the limits set by lambda and NA, mimic virtually any scanner and any reticle. It can produce yielding wafers even if there is no yielding mask process. The pattern can be seeded with programmed defects and errors to give specific and quantitative information about the yield tolerance of the product or the process. Shotgun design strategies can be supported. Every produced chip can have an electrically readable identity for yield analysis and error tracking, and unique keys for encryption and message signing can be added to any ship with no increase in process complexity. Maskless technology can aid in the development of high-value large-volume products. It can lower the threshold for low-volume products. It can make products with superior performance. It can enable niche products, e.g. SoC devices. Every fab, every engineer will have his way to make use of it. More products with better design, faster to the market, and at lower cost are the opportunities.

Sometime in the future, we expect the phase-shifting maskless scanner to spread through-out the industry. OPC and phase-shifting lithography will develop much more quickly than in our present world, thanks to faster learning. Yields will be higher. Engineers will about it using OML much as you and I think about the laser printer. They will use it every day as part of their infrastructure, a tool of the trade. If it were taken away from these future engineers, they would have to sit down and find work-arounds and ways to cope without it. Still, OML will not displace reticle-based lithography, any more than the laser printer has replaced book and newspaper printing presses.

Summary

We have shown that the tilting phase-step mirror (and an equivalent piston hybrid) has the power to work as a strong phase-shifting reticle in a wide range of uses. At the same time the phase-step mirror has surprisingly benign properties in terms of data crunching, and the current data path in the Sigma maskwriter can be modified for phase-shifting. Both the SLM and the data path needed for phase-shifting lithography constitute only modest modifications from what is already used in the Sigma 7300. Going from a maskwriter to a maskless scanner is more an act of scaling and repackaging of the technology than a genuine new development. Furthermore, having demonstrated of the function and performance of the SLM technology in the Sigma 7300, there is little technical uncertainty about the feasibility of a tool based on tilting-mirror SLM technology. What we have presented here is a full working architecture for a maskless system, and most elements of it are already in field use in the Sigma mask writers.

The new development needed for a phase-shifting maskless tool is the phase-shifting phase-step mirror which in simulation appears to have very attractive and powerful properties. We have argued that a system like this can essentially match and surpass any reticle-based lithography, except for throughput, and that it enables new technical niches and business segments that standard lithography cannot address. Moreover, maskless phase-shifting lithography facilitates and accelerates learning both on the fab and industry levels.

We have seen the Sigma maskwriter go from the first crude models in Excel to a complete commercial system with state-of-the-art performance, and the theory has materialized exactly as predicted. Therefore, it is with confidence that we now predict how the tilting phase-shifting phase-step mirror will work and that it can change the industry.

### REFERENCES

1. C. Rydberg, “Laser Mask Writers”, in S. Rizvi, “Handbook of Mask Making”, Taylor & Francis (to be published)

2. T. Sandstrom, A. Bleeker, J. Hintersteiner, K. Trost, J. Freyer, K. v. d. Mast, “OML: Optical Maskless Lithography for Economic Design Prototyping and Small-Volume Production”, Proc. SPIE, 5377, p. 777 (2004)

3. T. Sandstrom, H. Martinsson: “RET for Optical Maskless Lithography”, Proc. SPIE, 5377, p. 1750 (2004)

4. H. Martinsson, T. Sandstrom, “Rasterizing for SLM-based mask-making and maskless lithography”, Proc. SPIE, 5567, Bellingham, (to be published)

5. U. Ljungblad, H. Martinsson and T. Sandstrom, “Phase Shifted Addressing using a Spatial Light Modulator”, MNE (Micro- and Nano-Engineering) 2004 Proceedings

6. U. Ljungblad, “High-end masks manufacturing using Spatial Light Modulators”, Solid State Technology

7. Y. Schroff, Y. Chen, W. Oldham, “Image optimization for Maskless Lithography”, Proc. SPIE, 5374 p. 619 (2004)

8. E. Croffie, N. Eib, N. BabaAli, J. Hintersteiner, N. Callan, T. Sandstrom, A. Bleeker, K. Cummings, and A. Latypov, “Application of Rigorous Electromagnetic Simulation to SLM-based Maskless Lithography”, Proc. SPIE, 842 (2003)

9. “Introduction to Fourier Optics”, J. W. Goodman, McGraw-Hill, New York, 1996

10. www.xinitiative.org

11. P. Senge, “The Fifth Discipline”, Currency Doubleday, New York, 1990

12. DeWitt, B. S., Graham, N., “The Many Worlds Interpretation of Quantum Mechanics”, Princeton University Press, Princeton N.J., 1983

Some Particular Embodiments

The present invention may be practiced as a method or device adapted to practice the method. The invention may be an article of manufacture such as media impressed with logic to carry out maskless emulation of phase-shifting methods and generation of OPC features.

One embodiment is a method of exposing lithographic patterns, including providing a spatial light modulator (SLM) having at least one mirror having a complex reflection coefficient with a negative real part and an adjacent mirror having a complex reflection coefficient with a positive real part. Throughout this application, adjacent means either adjoining or within five mirrors, as the interference effects of relaying partially coherent light from nearby micromirrors is limited by their proximity. The method further includes illuminating said SLM with the partially coherent beam and converting vector data to drive said SLM. The vector input data includes more than two beam relaying states, is used in one or more methods of lithographic image enhancement used with reticles. These methods of lithographic image enhancement are chosen from among the group of CPL, phase edge, alternating aperture (Levinson type), three tone or high-transmittance attenuating lithography. The more than two beam relaying states may include fully on and fully off plus either a gray area or a phase shifted area, described in vector data before rasterizing.

A further aspect of the first embodiment includes defining one or more pattern edges with the SLM using at least one mirror oriented to have a complex reflection coefficient with a negative real part, emulating one or more of the methods of lithographic image enhancement.

A series of the additional embodiments involve emulating particular methods of lithographic image enhancement. One of these embodiments is a method of forming lithographic patterns on an image plane on a work piece using a spatial light modulator having one or more mirrors having a complex reflection coefficient with a negative real part, using the partially coherent light, including illuminating the SLM with the partially coherent light. The method further includes driving the mirrors having the complex reflection coefficient with a negative real part to a phase edge as contrasted with one or more adjacent mirrors and projecting the partially coherent light from the SLM through a finite aperture onto an image plane.

Another these embodiments is a method of forming lithographic patterns on an image plane on a work piece using a spatial light modulator having one or more mirrors having a complex reflection coefficient with a negative real part, using the partially coherent light, including illuminating the SLM with the partially coherent light. The method further includes driving the mirrors having the complex reflection coefficient with a negative real part to emulate phase interference between areas of a CPL mask and projecting the partially coherent light from the SLM through a finite aperture onto an image plane.

A further embodiment is a method of forming lithographic patterns on an image plane on a work piece using a spatial light modulator having one or more mirrors having a complex reflection coefficient with a negative real part, using the partially coherent light, including illuminating the SLM with the partially coherent light. The method further includes driving the mirrors having the complex reflection coefficient with a negative real part to emulate an alternating aperture phase-shifting mask and projecting the partially coherent light from the SLM through a finite aperture onto an image plane.

Yet another embodiment is a method of forming lithographic patterns on an image plane on a work piece using a spatial light modulator having one or more mirrors having a complex reflection coefficient with a negative real part, using the partially coherent light, including illuminating the SLM with the partially coherent light. The method further includes driving the mirrors having the complex reflection coefficient with a negative real part to emulate a three-tone phase-shifting mask and projecting the partially coherent light from the SLM through a finite aperture onto an image plane.

A related embodiment is a method of forming lithographic patterns on an image plane on a work piece using a spatial light modulator having one or more mirrors having a complex reflection coefficient with a negative real part, using the partially coherent light, including illuminating the SLM with the partially coherent light. The method further includes driving the mirrors having the complex reflection coefficient with a negative real part to emulate a high transmission attenuating phase-shifting mask and projecting the partially coherent light from the SLM through a finite aperture onto an image plane.

Another embodiment disclosed is a method of exposing lithographic patterns including providing a spatial light modulator having at least one mirror having a complex reflection component with a negative real part and adjacent mirror having a complex reflection coefficient with a positive real part. This method includes illuminating the SLM with the partially coherent been and converting vector input data to drive the SLM. The vector input data includes OPC features or decompositions, has used to produce lithographic image enhancement used with reticles. The OPC features or decompositions are among the group of scatter bars, serifs, OPC jogs, or double-dipole decompositions.

A series of related embodiments involve emulating OPC features or decompositions as used with reticles. One related embodiment is a method of forming lithographic patterns on an image plane on a workpiece using a spatial light modulator having one or more mirrors having a complex reflection coefficient with a negative real part, using a partially coherent light, including illuminating the SLM with the partially coherent illumination source. The method further includes driving the mirrors to emulate one or more sub-printing resolution scatter bars and projecting the partially coherent light from the SLM through a finite aperture onto an image plane.

Another related embodiment is a method of forming lithographic patterns on an image plane on a workpiece using a spatial light modulator having one or more mirrors having a complex reflection coefficient with a negative real part, using a partially coherent light, including illuminating the SLM with the partially coherent illumination source. The method further includes driving the mirrors to emulate a sub-printing resolution serifs and projecting the partially coherent light from the SLM through a finite aperture onto an image plane.

A further embodiment is a method of forming lithographic patterns on an image plane on a workpiece using a spatial light modulator having one or more mirrors having a complex reflection coefficient with a negative real part, using a partially coherent light, including illuminating the SLM with the partially coherent illumination source. The method further includes driving the mirrors to produce a jogging align pattern, enhanced by a phase difference between adjacent mirrors of the SLM and projecting the partially coherent light from the SLM through a finite aperture onto an image plane.

A yet further embodiment is a method of forming lithographic patterns on an image plane on a workpiece using a spatial light modulator having one or more mirrors having a complex reflection coefficient with a negative real part, using a partially coherent light, including illuminating the SLM with the partially coherent illumination source. The method further includes driving the mirrors to emulate double-exposure dipole decomposition resolution enhancement using multiple exposures of the SLM and projecting the partially coherent light from the SLM through a finite aperture onto an image plane.

Generally, among embodiments, these are methods of direct writing to a workpiece including receiving data that describes one or more masks applying phase shifting techniques to produce an image on the workpiece. These methods further include driving complex amplitude-capable micromirrors of an SLM to emulate the image on the workpiece that would be produced by the one or more masks and illuminating the SLM with partially coherent light and relaying the partially coherent light onto the workpiece. In a further aspect of these methods, the one or more masks applying phase shifting techniques are actually two or more masks of a mask set used to produce an image on the workpiece for a particular pattern layer.

Additional Embodiments

An additional embodiment is a method of producing a complex valued amplitude signal by relaying radiation from paired reflective piston elements in a spatial light modulator. The method includes pairing reflective piston elements having a reference difference in surface height substantially equal to a positive natural number (1, 2, 3 . . . ) multiple of one quarter wavelength of an electromagnetic radiation used to illuminate the paired piston elements. It further includes transmitting one or more control signals to the paired piston elements to actuate the paired piston elements to produce a complex valued amplitude signal and relaying electromagnetic radiation from a multitude of the paired piston elements toward an image plane.

According to one aspect of this embodiment, pairs of the paired piston elements define a square. Or, pairs of the paired piston elements may be symmetrical about either an axis or point between them. In another aspect. Each piston of the paired piston elements may have a length to width ratio of approximately two-to-one.

The reference difference in surface height between paired piston elements may be correctable by calibration to a positive natural number (1, 2, 3 . . . ) multiple of one quarter wavelength. Alternatively, the reference difference in surface height between paired piston elements may refer to an initial operating condition achieved by actuating the paired piston elements, while still supporting a range of further actuation that produces complex amplitudes of relayed electromagnetic radiation from −1+0j to +1+0j.

By a further aspect of this embodiment, the controlled signals actuate the paired piston elements to produce imaginary parts of the complex valued amplitude that substantially cancel each other, so that the complex valued amplitude signal of the paired piston elements has an imaginary part that is substantially equal to zero. In this sense, substantially equal to zero means that the relayed electromagnetic radiation is sufficiently resistant to image shifting through focus to be practically applied. In an alternative aspect, a vector sum of complex valued amplitude signal components from the paired reflective piston elements has an imaginary part that is substantially equal to zero.

Another embodiment is a method of producing a complex valued amplitude signal by relaying radiation from a phase stepped centrally pivoting mirror element in a spatial light modulator. This method includes transmitting one or more control signals to phase stepped centrally pivoting mirror elements to actuate the mirror elements to produce a complex valued amplitude signal. In this method, first and second surface portions of the mirror elements have a difference in surface site substantially equal to a positive natural number (1, 2, 3 . . . ) multiple of one quarter wavelength of an electromagnetic radiation used to illuminate them. In addition, a vector sum of complex valued amplitude signal components from the first and second portions may have an imaginary part that is substantially equal to zero. The method further includes relaying the electromagnetic radiation from a multitude of the mirror elements toward an image plane.

The aspects applied above to paired piston elements likewise apply to phase stepped mirrors. The first and second portions may collectively define a square. The first and second surface portions may be symmetrical about an axis or a point between them. They may each have a length to width ratio of two-to-one. The reference difference in surface height between the first and second portions may be correctable by calibration so that they can be used as if the difference were a positive natural number multiple of one quarter wavelength.

Another embodiment is a method of composing a rasterized image using mirrors a spatial light modulator. This method includes receiving data describing two pattern layers of a pattern to be generated using the spatial light modulator, the spatial light modulator including a multitude of elements. It further includes rasterizing the data describing the two pattern layers and, in real-time, combining the data describing the two pattern layers and producing one set of signals controlling the multitude of elements of the SLM.

According to one aspect of this embodiment, the multitude of elements produce complex valued amplitude signals when relaying electromagnetic radiation. The two pattern layers may describe patterns of three or four grayscale amplitudes to be produced in an imaging plane by the multitude of elements when relaying electromagnetic radiation. The two pattern layers may utilize both negative and positive amplitudes of the electromagnetic radiation. The data may be combined after rasterizing the pattern layers in parallel. Alternatively, or cumulatively, the data may be combined in a pipeline with rasterizing the patent layers. This pipeline computer hardware architecture may use of a volatile buffer memory. The data may be combined in a linear combination. In this sense, a linear combination means a met applying a mathematical linear operator.

A further aspect of this embodiment includes driving particular elements of the SLM to produce complex amplitude signals having as great a range of negative amplitude as their range of positive amplitude. The complex amplitude signal produced by particular elements may have an imaginary part substantially equal to zero.

While the present invention is disclosed by reference to the preferred embodiments and examples detailed above, it is understood that these examples are intended in an illustrative rather than in a limiting sense. Computer-assisted processing is implicated in the described embodiments. Accordingly, the present invention may be embodied in methods for using phase shifting elements of an SLM to produce results equivalent to alternating phase shift (hard phase shift) masks, systems including logic and resources to carry out actuation of phase shifting elements to produce equivalent results, or media impressed with logic to carry out actuation of phase shifting elements to produce equivalent results. It is contemplated that modifications and combinations will readily occur to those skilled in the art, which modifications and combinations will be within the spirit of the invention and the scope of the following claims.

We claim as follows:

1. A method of producing a complex valued amplitude signal by relaying radiation from paired reflective piston elements in a Spatial Light Modulator (SLM), the method including:
pairing reflective piston elements having a reference difference in surface height substantially corresponding to a positive natural number multiple (1, 2, 3 . . . ) of one quarter wavelength of an electromagnetic radiation used to illuminate the paired piston elements;
transmitting one or more control signals to the paired piston elements to actuate the paired piston elements to produce a complex valued amplitude signal; and
relaying the electromagnetic radiation from a multitude of the paired piston elements toward and image plane.

2. The method of claim 1, wherein pairs of the paired piston elements define a square.

3. The method of claim 1, wherein pairs of the paired piston elements are symmetrical about an axis between them.

4. The method of claim 1, wherein pairs of the paired piston elements are symmetrical about a point between them.

5. The method of claim 1, wherein each piston of the paired piston elements has a length to width ratio of approximately two-to-one.

6. The method of claim 1, wherein the reference difference in surface height between paired piston elements is correctable by calibration to a positive natural number (1, 2, 3 . . . ) multiple of one quarter wavelength.

7. The method of claim 1, wherein the reference difference in surface height between paired piston elements refers to an initial operating condition achieved by actuating the paired piston elements, while still supporting a range of further actuation that produces complex amplitudes of relayed electromagnetic radiation from −1+0j to +1+0j.

8. The method of claim 1, wherein the control signals actuate the paired piston elements to produce imaginary parts of the complex valued amplitude that substantially cancel each other, so that the complex valued amplitude signal of the paired piston elements has an imaginary part that is substantially equal to zero.

9. The method of claim 1, wherein a vector sum of complex valued amplitude signal components from the paired reflective piston elements has an imaginary part that is substantially equal to zero.

10. A method of producing a complex valued amplitude signal by relaying radiation from a phase stepped centrally pivoting mirror element in a Spatial Light Modulator (SLM), the method including:
transmitting one or more control signals to phase stepped centrally pivoting mirror elements to actuate the mirror elements to produce a complex valued amplitude signal;
wherein first and second surface portions of the mirror elements have a difference in surface height substantially equal to a positive natural number (1, 2, 3 . . . ) multiple of one quarter wavelength of an electromagnetic radiation used to illuminate them;
wherein a vector sum of complex valued amplitude signal components from the first and second portions has an imaginary part that is substantially equal to zero; and
relaying the electromagnetic radiation from a multitude of the mirror elements toward an image plane.

11. The method of claim 10, wherein the first and second surface portions collectively define a square.

12. The method of claim 10, wherein the first and second surface portions are symmetrical about an axis between them.

13. The method of claim 10, wherein the first and second surface portions are symmetrical about a point between them.

14. The method of claim 10, wherein the first and second surface portions each have a length to width ratio of two-to-one.

15. The method of claim 10, wherein the reference difference in surface height is correctable by calibration to be used as if the difference were a positive natural number (1, 2, 3 . . . ) multiple of one quarter wavelength.

16. A method of composing a rasterized image using mirrors of a Spatial Light Modulator, the method including:
receiving data describing two pattern layers of a pattern to be generated using the Spatial Light Modulator (SLM), the SLM including a multitude of elements;
rasterizing the data describing the two pattern layers; and
in real time, combining the data describing the two pattern layers and producing one set of signals controlling the multitude of elements of the SLM.

17. The method of claim 16, wherein the multitude of elements produce complex valued amplitude signals when relaying electromagnetic radiation.

18. The method of claim 16, wherein the two pattern layers describe patterns of three or four grayscale amplitudes to be produced by the multitude of elements when relaying electromagnetic radiation.

19. The method of claim 18, wherein the two pattern layers utilize both negative and positive amplitudes of the electromagnetic radiation.

20. The method of claim 16, wherein the data are combined after rasterizing the pattern layers in parallel.

21. The method of claim 16, wherein the data are combined in a pipeline with rasterizing the pattern layers.

22. The method of claim 16, wherein the data are combined in a linear combination.

23. The method of claim 16, further including driving particular elements of the SLM to produce complex amplitude signals having as great a range of negative amplitude as their range of positive amplitude.

24. The method of claim 23, wherein the complex amplitude signal produced by particular elements has an imaginary part substantially equal to zero.
